(19) United States
(12) Patent Application Publication
(10) Pub. No.: US 2023/0342797 A1
(43) Pub. Date: Oct. 26, 2023

(54) OBJECT PROCESSING METHOD BASED ON TIME AND VALUE FACTORS

(71) Applicant: Tencent Technology (Shenzhen) Company Limited, Shenzhen (CN)

(72) Inventors: Yang QIAO, Shenzhen (CN); Liang CHEN, Shenzhen (CN); Gaolin FANG, Shenzhen (CN)

(73) Assignee: Tencent Technology (Shenzhen) Company Limited, Shenzhen (CN)

(21) Appl. No.: 18/215,303

(22) Filed: Jun. 28, 2023

Related U.S. Application Data
(63) Continuation of application No. PCT/CN2022/125251, filed on Oct. 14, 2022.

(30) Foreign Application Priority Data
Dec. 8, 2021 (CN) 202111492149.2

(51) Int. Cl. G06Q 30/0202

(52) U.S. Cl. CPC G06Q 30/0202

(57) ABSTRACT

An object processing method includes acquiring a historical interaction feature of a user with a historical resource object corresponding to a target resource object, and acquiring a historical status feature of the historical resource object, the historical status feature indicating a change of a resource attribute of the historical resource object. The method further includes determining a conversion prediction feature of the user for the target resource object at a current time based on the historical interaction feature and the historical status feature, and predicting a conversion possibility degree of the user for the target resource object at the current time based on the conversion prediction feature, to determine whether to communicate with the user regarding the target resource object based on the conversion possibility degree.

### RELATED APPLICATIONS

This application is a continuation of International Application No. PCT/CN2022/125251, filed on Oct. 14, 2022, which claims priority to Chinese Patent Application No. 202111492149.2, entitled “OBJECT PROCESSING METHOD AND APPARATUS, COMPUTER DEVICE, AND STORAGE MEDIUM” filed on Dec. 8, 2021. The disclosures of the prior applications are hereby incorporated by reference in their entirety.

### FIELD OF THE TECHNOLOGY

This application relates to the field of computer technologies, including an object processing method and apparatus, a computer device, and a storage medium.

### BACKGROUND OF THE DISCLOSURE

With the development of a computer technology and Internet technology, it has become increasingly common to push content to users through the Internet, for example, display advertisements to the users or issue coupons to the users. Different user groups may respond differently to same pushed content, so a target user is often selected from the users before the content is pushed, and then the content is pushed to the target user.

In related technology, the target user is typically selected from the user group based on personal experience, and the content is then pushed to the target user but not to a non-target user in the user group. However, manual screening may lead to a significant error, so the selected target user is not necessarily an audience of the pushed content, and a user that the content is not pushed to may be an audience of the content. As a result, a user processing manner is not so accurate.

### SUMMARY

According to various embodiments provided in this disclosure, an object processing method and apparatus, a computer device, a storage medium, and a computer program product are provided.

In an embodiment, an object processing method includes acquiring a historical interaction feature of a user with a historical resource object corresponding to a target resource object, and acquiring a historical status feature of the historical resource object, the historical status feature indicating a change of a resource attribute of the historical resource object. The method further includes determining a conversion prediction feature of the user for the target resource object at a current time based on the historical interaction feature and the historical status feature, and predicting a conversion possibility degree of the user for the target resource object at the current time based on the conversion prediction feature, to determine whether to communicate with the user regarding the target resource object based on the conversion possibility degree.

In an embodiment, an object processing apparatus includes processing circuitry configured to acquire a historical interaction feature of a user with a historical resource object corresponding to a target resource object, and acquire a historical status feature of the historical resource object, the historical status feature indicating a change of a resource attribute of the historical resource object. The processing circuitry is further configured to determine a conversion prediction feature of the user for the target resource object at a current time based on the historical interaction feature and the historical status feature, and predict a conversion possibility degree of the user for the target resource object at the current time based on the conversion prediction feature, to determine whether to communicate with the user regarding the target resource object based on the conversion possibility degree.

In an embodiment, a non-transitory computer-readable storage medium stores computer-readable instructions that, when executed by processing circuitry, cause the processing circuitry to perform an object processing method. The method includes acquiring a historical interaction feature of a user with a historical resource object corresponding to a target resource object, and acquiring a historical status feature of the historical resource object, the historical status feature indicating a change of a resource attribute of the historical resource object. The method further includes determining a conversion prediction feature of the user for the target resource object at a current time based on the historical interaction feature and the historical status feature, and predicting a conversion possibility degree of the user for the target resource object at the current time based on the conversion prediction feature, to determine whether to communicate with the user regarding the target resource object based on the conversion possibility degree.

Details of one or more embodiments of this disclosure will be proposed in the following drawings and descriptions. Other features, objectives, and advantages of this disclosure will become apparent in the specification, the drawings, and the claims.

### BRIEF DESCRIPTION OF THE DRAWINGS

To describe the technical solutions in the embodiments of this disclosure more clearly, the following briefly describes the accompanying drawings describing the embodiments. It is clear that the accompanying drawings in the following description show merely some embodiments of this disclosure, and a person of ordinary skill in the art may still derive other drawings from these accompanying drawings.

FIG. 1 is a diagram of an application environment of an object processing method according to some embodiments.

FIG. 2 is a schematic flowchart of an object processing method according to some embodiments.

FIG. 3 is a diagram of comparison between a Shanghai stock exchange composite index and a delivery conversion rate according to some embodiments.

FIG. 4 is a diagram of structures of a feature generation model and an object conversion prediction model according to some embodiments.

FIG. 5 is a diagram of a structure of a feature processing network according to some embodiments.

FIG. 6 is a schematic diagram of a sample space of a full scenario according to some embodiments.

FIG. 7 is a schematic flowchart of an object processing method according to some embodiments.

FIG. 8 is a block diagram of a structure of an object processing apparatus according to some embodiments.

FIG. 9 is a diagram of an internal structure of a computer device according to some embodiments.

FIG. 10 is a diagram of an internal structure of a computer device according to some embodiments.

### DESCRIPTION OF EMBODIMENTS

To make the objectives, technical solutions, and advantages of this disclosure clearer, the following further describes this disclosure in detail with reference to the accompanying drawings and the embodiments. It is to be understood that specific embodiments described herein are only for describing this disclosure and not intended to limit this disclosure.

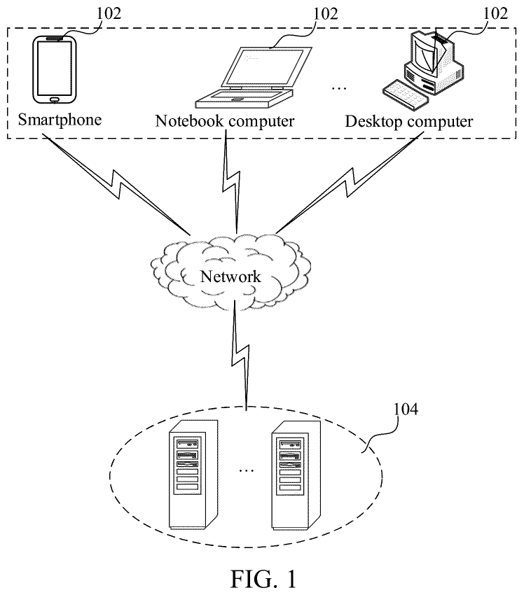

An object processing method provided in this disclosure may be applied to an application environment shown in FIG. 1. A terminal 102 communicates with a server 104 through a network.

Specifically, the server 104 may acquire a historical interaction feature of a user object for a historical resource object, acquire a historical status feature of a dynamic influencing factor of the historical resource object, the dynamic influencing factor being used for dynamically influencing a change of a resource attribute of a target resource object, and the historical status feature being determined based on historical status information of the dynamic influencing factor, determine a conversion prediction feature of the user object for a target resource object at current time based on the historical interaction feature and the historical status feature, and predict a conversion possibility degree of the user object for the target resource object based on the conversion prediction feature, to determine a processing manner for the user object based on the conversion possibility degree.

The object processing method provided in this disclosure may be applied to the field of finance. For example, the target resource object may be a fund, the user object may be a user who purchases or follows the fund, and the conversion possibility degree is a probability that the user purchases the fund. According to the object processing method provided in this disclosure, the probability that the user purchases the fund may be determined. When the probability that the user purchases the fund is greater than a probability threshold, some content such as a coupon is pushed to the user to motivate the user to purchase the fund. When the probability that the user purchases the fund is less than a probability threshold, no processing is performed for the user. The probability threshold may be preset or set as required, for example, is 0.6.

It is to be noted that user information (including, but not limited to, user equipment information, personal information of a user, and the like) and data (including, but not limited to, data for analysis, stored data, displayed data, and the like) involved in this disclosure are information and data authorized by the user or fully authorized by all parties, and collection, use, and processing of related data need to comply with related laws and regulations and standards of related countries and regions. For example, information involved in this disclosure, for example, a user object, a user resource object, an interaction feature, and a status feature reference, is all acquired with a full authority.

The terminal 102 may be but is not limited to various personal computers, notebook computers, smartphones, tablet computers, and portable wearable devices. The server 104 may be implemented by an independent server or a server cluster including a plurality of servers.

The object processing method provided in this disclosure may be based on artificial intelligence. For example, in this disclosure, the historical interaction feature and the historical status feature may be processed by using a feature generation model, thereby determining the conversion prediction feature of the user object for the target resource object at the current time. The feature generation model is an artificial-intelligence-based model, for example, a trained neural network model, and is configured to generate the conversion prediction feature. For another example, in this disclosure, the conversion prediction feature may be processed by using an object conversion prediction model, thereby obtaining the conversion possibility degree of the user object for the target resource object. The object conversion prediction model is an artificial-intelligence-based model, for example, a trained neural network model, and is configured to predict the conversion possibility degree.

It may be understood that the foregoing application scenario is merely an example, and does not constitute a limitation on the object processing method provided in the embodiments of this disclosure. The method provided in the embodiments of this disclosure may also be applied to another application scenario. For example, the object processing method provided in this disclosure may be performed by the terminal 102. The terminal 102 may upload the obtained conversion possibility degree corresponding to the user object to the server 104. The server 104 may store the conversion possibility degree corresponding to the user object, or may forward the conversion possibility degree corresponding to the user object to another terminal device.

In some embodiments, as shown in FIG. 2, an object processing method is provided. The method may be performed by a terminal, may be performed by a server, or may be performed by a terminal and a server. Application of the method to the server 104 in FIG. 1 is used as an example for description. The method includes the following steps:

Step 202: Acquire a historical interaction feature of a user object for a historical resource object. For example, a historical interaction feature of a user with a historical resource object corresponding to a target resource object is acquired.

The user object may be any natural person, for example, a user using an application program. The application program includes but is not limited to shopping software or financial software, for example, financial management software. A resource object may be a virtual resource, including, but not limited to, game equipment, a pet in a game, an electronic coupon, an electronic red packet, or the like. Alternatively, a resource object may be a real resource, including, but not limited to, cash or a physical gift. The historical resource object is a resource object for which the user object performs an interactive behavior in historical time. The historical resource object may include a resource object for which the user object performs an interactive behavior in all time before current time, or may be a resource object for which the user object performs an interactive behavior in a period of time before current time. The interactive behavior between the user object and the resource object may include purchase, following, click, or subscription. For example, purchase means that the user object purchases the resource object, and may be offline purchase or online purchase. Following may be a following operation performed by the user object on the resource object through the Internet, for example, a following operation on a financial management product displayed in financial management application software. Click is a click operation performed by the user object on the resource object through the Internet. Subscription is an operation performed by the user object through the Internet to subscribe for the resource object. For example, when the user object purchased a resource object A in historical time, the resource object A is a historical resource object.

The historical interaction feature is a feature corresponding to historical interaction data. The historical interaction data may correspond to an interaction moment. The interaction moment is a moment at which the historical interaction data is generated, that is, a moment at which the user object interacts with the resource object, for example, a moment at which the user object visits a fund A. The historical interaction feature is obtained based on the historical interaction data, so that the interaction moment corresponding to the historical interaction data is a moment at which the historical interaction feature is generated. Therefore, the interaction moment corresponding to the historical interaction data is also an interaction moment corresponding to the historical interaction feature. For example, when the historical interaction data is interaction data of the user object generated at a moment A, the moment corresponding to the historical interaction feature is the moment A. The historical interaction data may be stored in the server, or may be acquired by the server from another device. The historical interaction data includes information of the historical resource object or an interactive behavior type. The information of the historical resource object includes but is not limited to an identifier of the historical resource object or a price of the historical resource object.

The interactive behavior type may be any behavior in a conversion link. The conversion link includes an interactive behavior required to be performed by the user object during conversion for the resource object. The interactive behavior in the conversion link includes but is not limited to visit, click, or subscription. Each resource object may correspond to a conversion link. Conversion links corresponding to different resource objects may be the same or different. The interactive behavior in the conversion link is arranged based on a behavior occurrence sequence. An interactive behavior corresponding to an earlier behavior occurrence sequence has a higher ranking in the conversion link. An interactive behavior corresponding to a late behavior occurrence sequence occurs after an interactive behavior corresponding to an early behavior occurrence sequence occurs. For example, “click” occurs after “visit”, so a behavior occurrence sequence of “visit” is early, while a behavior occurrence sequence of “click” is late. Therefore, in the conversion link, “visit” is arranged before “click”. For example, the conversion link may be “visit [symbol] click [symbol] subscription”. Occurrence of conversion means that the user object performs all interactive behaviors in the conversion link on the resource object, that is, the last interactive behavior in the conversion link occurs. For example, if a conversion link for the resource object A is “visit [symbol] click [symbol] subscription”, when a subscription behavior occurs between the user object and the resource object, it is determined that the user object is converted for the resource object A.

Specifically, the server may acquire the historical interaction data of the user object, and encode the historical interaction data to obtain the historical interaction feature. When the historical interaction data includes data of a plurality of dimensions, data of each dimension may be encoded to obtain an encoded feature corresponding to the data of each dimension. Each encoded feature is combined, for example, concatenated, to obtain the historical interaction feature. For example, the historical interaction data is “fund A, price of fund A, purchase”, and “fund A”, “price of fund A”, and “purchase” are separately encoded to obtain encoded features respectively corresponding to the three pieces of data. A used encoding method may be any encoding algorithm, including, but not limited to, one-hot encoding. Certainly, the data may be input to an embedding layer to obtain the encoded feature.

In some embodiments, the server may acquire a historical interaction data sequence of a user in a preset time range. The historical interaction data sequence includes a plurality of pieces of historical interaction data. The historical interaction data corresponds to different interaction moments. That is, the historical interaction data is interaction data of the user object generated at different moments. The historical interaction data in the historical interaction data sequence is arranged based on the interaction moments. Historical interaction data corresponding to an earlier interaction moment has a higher ranking in the historical interaction data sequence. The server may encode each piece of historical interaction data in the historical interaction data sequence to obtain a historical interaction feature corresponding to each piece of historical interaction data. The preset time range is a time range before current time. Resource objects corresponding to historical interaction data of the user object generated at different moments may be different or the same. For example, in the historical interaction data sequence, historical interaction data corresponding to a moment T₁ is data about fund visit of the user object, and historical interaction data corresponding to a moment T₂ is data about computer purchase of the user object. In this case, a resource object corresponding to the moment T₁ is a fund, and a resource object corresponding to the moment T₂ is a computer. The server may arrange each historical interaction feature based on the interaction moments to obtain a historical interaction feature sequence. A historical interaction feature corresponding to an earlier interaction moment has a higher ranking in the historical interaction feature sequence. The historical interaction feature sequence includes historical interaction features of the user object generated at a plurality of moments. Therefore, interests and preferences of the user may be reflected.

Step 204: Acquire a historical status feature of a dynamic influencing factor of the historical resource object, the dynamic influencing factor being used for dynamically influencing a change of a resource attribute of the historical resource object, and the historical status feature being determined based on historical status information of the dynamic influencing factor. For example, a historical status feature of the historical resource object is acquired, where the historical status feature indicates a change of a resource attribute of the historical resource object.

The dynamic influencing factor is a factor that dynamically influences the change of the resource attribute of the historical resource object, and includes but is not limited to a resource factor (value factor) or a time factor. The resource factor is a resource related factor. The resource factor corresponds to resource information (value information). For example, the resource information may include market condition information. The market condition information includes but is not limited to a Shanghai stock exchange composite index, a Dow Jones index, a US dollar index, or a new energy industry index. The resource information may further include change information of the market condition information, including, but not limited to, an index change of the Shanghai stock exchange composite index, the Dow Jones index, the US dollar index, or the new energy industry index. The time factor is a time related factor. The time factor corresponds to time information. The time information includes but is not limited to week, month, day, a first transaction identifier, or a second transaction identifier. The first transaction identifier is any one of a trading day identifier or a non-trading day identifier. The second transaction identifier is any one of a trading time identifier or a non-trading time identifier. The trading day identifier is used for representing a trading day. The non-trading day identifier is used for representing a non-trading day. The trading time identifier is used for representing trading time. The non-trading time identifier is used for representing non-trading time. For example, 1 is used as the trading day identifier, and 0 is used as the non-trading day identifier.

The historical status information of the dynamic influencing factor corresponds to a historical moment. Different historical status information corresponds to different historical moments. The historical status information of the dynamic influencing factor is used for representing a status of the dynamic influencing factor at the historical moment or in a period of time before the historical moment. For example, historical status information corresponding to the moment T₁ is used for representing a status of the dynamic influencing factor at the moment T₁ or a status in a period of time before the moment T₁. When the dynamic influencing factor is the time factor, the historical status information is time information corresponding to the historical moment, and may include at least one of week/month/which day, which hour, the trading day identifier or a trading period identifier corresponding to the historical moment. When the dynamic influencing factor is the resource factor, the historical status information may be resource information corresponding to the historical moment, for example, a Shanghai stock exchange composite index corresponding to the historical moment, or may be a change of resource information in a period of time before the historical moment, for example, changes of major global market and industry indexes such as the Shanghai stock exchange composite index, the Dow Jones index, the US dollar index, or the new energy industry index in last 1 day/7 days/30 days corresponding to the historical moment. The historical status information of the dynamic influencing factor may be stored in the server, or may be acquired by the server from another device.

The historical status feature of the dynamic influencing factor is a feature obtained by encoding the historical status information of the dynamic influencing factor. The historical moment corresponding to the historical status feature of the dynamic influencing factor is consistent with that corresponding to the historical status information of the dynamic influencing factor.

Specifically, the historical moment corresponding to the historical status feature may be an interaction moment corresponding to the historical interaction feature. The server may determine the interaction moment corresponding to the historical interaction feature, determine the historical resource object corresponding to the historical interaction feature, and acquire the historical status feature of the dynamic influencing factor of the historical resource object at the interaction moment corresponding to the historical interaction feature. For example, the historical interaction feature is a feature generated based on data of the user object about fund purchase at the moment T₁. In this case, the moment T₁ is an interaction moment, and the server may acquire a historical status feature of a dynamic influencing factor of the fund at the moment T₁. Therefore, the moments corresponding to the historical interaction feature and the historical status feature are the same. The server may encode the historical status feature to obtain the historical status feature.

In some embodiments, there are a plurality of historical interaction features. Historical resource objects corresponding to different historical interaction features may be different. Interaction moments corresponding to different historical interaction features may be different. For each historical interaction feature, the server may determine a historical resource object and an interaction moment that correspond to the historical interaction feature, and acquire a historical status feature of a dynamic influencing factor of the historical resource object at the interaction moment, for example, acquire historical status information of the dynamic influencing factor of the historical resource object at the interaction moment, and encode the historical status information to obtain the historical status feature. Therefore, one historical status feature may be acquired based on one historical interaction feature, and it is obtained based on the historical interaction feature that a moment corresponding to the historical status feature is an interaction moment corresponding to the historical interaction feature.

In some embodiments, the time information and the resource information are shown in Table 1.

TABLE 1
Time information and resource information

| Name | Example | Dimension |
|---|---|---|
| Time | Time T corresponds to which day in this | 5 |
| information | week/month, the time T corresponds to | |
| | which hour on that day, the time T belongs | |
| | to a trading day, and the time T is within | |
| | a trading period | |
| Resource | Changes of major global market and industry | 240 |
| information | indexes such as the Shanghai stock exchange | |
| | composite index, the Dow Jones index, the | |
| | US dollar index, or the new energy industry | |
| | index in last 1 day/7 days/30 days | |
| | corresponding to the time T | |

Step 206: Determine a conversion prediction feature of the user object for a target resource object at current time based on the historical interaction feature and the historical status feature. For example, a conversion prediction feature of the user for the target resource object is determined at a current time based on the historical interaction feature and the historical status feature.

The target resource object may be any resource object. The target resource object may be the same as or different from the historical resource object, for example, may be a fund. A resource attribute of the resource object is a resource related attribute, for example, may be a price of the resource object, for example, a price of the fund. The moments corresponding to the historical interaction feature and the historical status feature are the same, and both are the interaction moment corresponding to the historical interaction feature.

The conversion prediction feature is a feature for predicting a conversion possibility degree of the user object for the target resource object. The conversion possibility degree is a probability of conversion.

Specifically, the server may perform feature fusion based on the historical interaction feature and the historical status feature to obtain the conversion prediction feature of the user object for the target resource object at the current time. Feature fusion may be at least one of feature concatenation, feature addition, or feature multiplication.

In some embodiments, the server may perform a feature operation based on the historical interaction feature to obtain an incremental feature. The server may concatenate the historical interaction feature and the historical status feature to obtain a historical concatenated feature, perform a feature operation on the historical concatenated feature to obtain an incremental filtering feature corresponding to the incremental feature, and perform a filtering process on the incremental feature by using the incremental filtering feature, to obtain the conversion prediction feature of the user object for the target resource object at the current time. The feature operation includes at least one of a linear operation or a nonlinear operation. The linear operation includes but is not limited to a multiplication operation or an addition operation. The nonlinear operation includes but is not limited to an exponent operation, a logarithm operation, or a hyperbolic tangent (tanh function) operation. The filtering process may be implemented through feature multiplication. For example, when dimensions of the incremental filtering feature and the incremental feature are the same, the server may multiply numerical values at corresponding locations in the incremental filtering feature and the incremental feature to obtain the conversion prediction feature of the user object for the target resource object at the current time. When dimensions of the incremental filtering feature and the incremental feature are different, the server may first unify the dimensions of the incremental filtering feature and the incremental feature, and then perform feature multiplication on the incremental filtering feature and the incremental feature whose dimensions are unified, to obtain the conversion prediction feature of the user object for the target resource object at the current time.

In some embodiments, the server may acquire a trained feature generation model. The feature generation model is configured to generate the conversion prediction feature. The server may input the historical interaction feature and the historical status feature to the feature generation model to predictively obtain the conversion prediction feature.

In some embodiments, the target resource object may be a to-be-pushed resource object. The terminal may transmit a resource object pushing request for the target resource object to the server. The resource object pushing request may carry an identifier of the target resource object. The server may acquire a user object set in response to the resource object pushing request. For each user object in the user object set, a historical interaction feature of the user object for the historical resource object is acquired, and the historical status feature of the dynamic influencing factor of the historical resource object is acquired, so as to determine, based on acquired data, whether the user object is an audience of the target resource object. When it is determined that the user object is an audience of the target resource object, the target resource object is pushed to the user object. When it is determined that the user object is not an audience of the target resource object, the target resource object is not pushed to the user object.

Step 208: Predict the conversion possibility degree of the user object for the target resource object based on the conversion prediction feature, to determine a processing manner for the user object for the target resource object based on the conversion possibility degree. For example, a conversion possibility degree of the user for the target resource object is predicted at the current time based on the conversion prediction feature, to determine whether to communicate with the user regarding the target resource object based on the conversion possibility degree.

The processing manner includes but is not limited to motivation or ignoring. Motivation means performing a motivation operation on the user object to promote conversion of the user object for the target resource object. Ignoring means not performing a motivation operation on the user object for the target resource object. The motivation operation includes but is not limited to pushing the target resource object, pushing a coupon for purchasing the target resource object, and the like.

Specifically, the server may compare the conversion possibility degree with a possibility degree threshold. When it is determined that the conversion possibility degree is greater than the possibility degree threshold, it is determined that the processing manner for the user object is motivation. When it is determined that the conversion possibility degree is not greater than the possibility degree threshold, it is determined that the processing manner for the user object is ignoring. When the processing manner is motivation, it is determined that the user object is an audience of the target resource object. When the processing manner is ignoring, it is determined that the user object is not an audience of the target resource object. The possibility degree threshold may be preset or set as required, for example, may be 60%.

In some embodiments, the server may acquire a trained object conversion prediction model. The object conversion prediction model is configured to predict the conversion possibility degree based on the conversion prediction feature. The object conversion prediction model and the feature generation model may be obtained through independent training or joint training. For example, the server may acquire a training sample, input the training sample to a feature generation model, determine an output of the feature generation model as a sample conversion prediction feature, input the sample conversion prediction feature to an object conversion prediction model, determine an output of the object conversion prediction model as a sample conversion possibility degree, determine a model loss function based on the sample conversion possibility degree, adjust model parameters of the feature generation model and the object conversion prediction model by using a model loss value, and perform iterative training until both the feature generation model and the object conversion prediction model converge, to obtain the trained feature generation model and the trained object conversion prediction model.

In some embodiments, the target resource object is a to-be-pushed resource object. The server may acquire a user object set. The user object set includes a plurality of user objects. The user object in the user object set may be stored in the server, or may be acquired by the server from another device. For each user object in the user object set, the server may determine a processing manner for the user object by using the method including step 202 to step 208, acquire, from the user object set, a user object for whom a processing manner is motivation as a target user object, and push the target resource object to the target user object. The target user object is an audience of the target resource object.

In the object processing method, the historical interaction feature of the user object for the historical resource object is acquired. The historical status feature of the dynamic influencing factor of the historical resource object is acquired. The conversion prediction feature of the user object for the target resource object at the current time is determined based on the historical interaction feature and the historical status feature. The conversion possibility degree of the user object for the target resource object is predicted based on the conversion prediction feature, to determine the processing manner for the user object based on the conversion possibility degree. Because the dynamic influencing factor is used for dynamically influencing the change of the resource attribute of the historical resource object, and the historical status feature is determined based on the historical status information of the dynamic influencing factor, the historical status feature may reflect a historical status of the dynamic influencing factor of the target resource object. Because the historical interaction feature may reflect an interaction status of the user object for the historical resource object, determining the conversion prediction feature of the user object for the target resource object at the current time based on the historical interaction feature and the historical status feature ensures that both the interaction status of the user object for the resource object at historical time and the historical status of the dynamic influencing factor of the resource object are considered when the conversion prediction feature is obtained. This improves accuracy of the conversion prediction feature, and further improves accuracy of the conversion possibility degree obtained based on the conversion prediction feature. Therefore, when the processing manner for the user object is determined based on the conversion possibility degree, a processing manner suitable for the user object may be obtained. This improves accuracy of the processing manner for the user object. It may be understood that a processing manner determined for the user object by using a related method is not so accurate, and a computer may consequently perform some ineffective processing, resulting in waste of computer resources. In this disclosure, the accuracy of the processing manner is improved, so that ineffective processing may be reduced to some extent, and computer resources are saved.

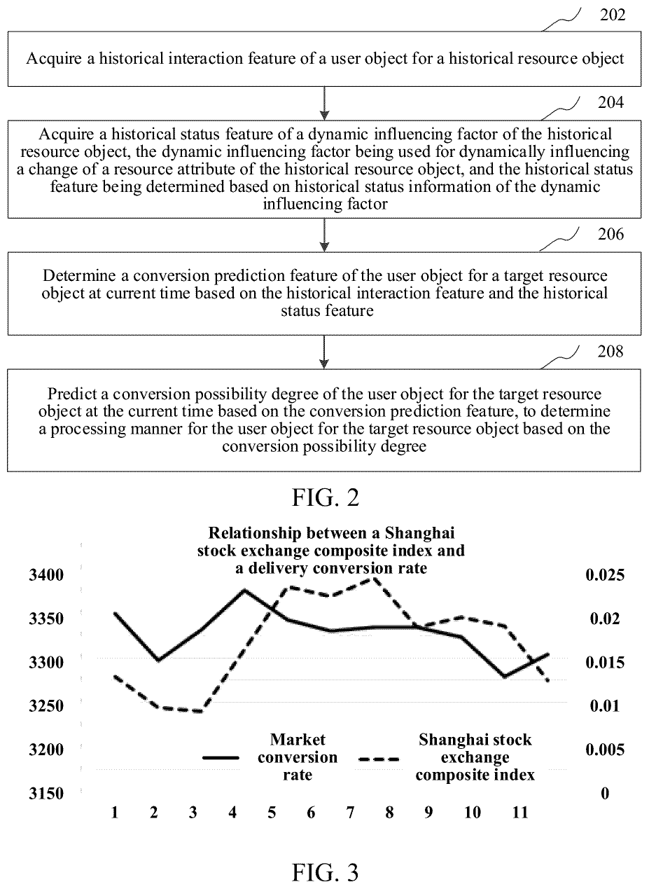

According to research findings, decision-making of a user in a financial marketing scenario is influenced by a market condition, time, or other factors, and decision-making (for example, click and subscription for a financial management product) of the user in a financial scenario is influenced by the market, time, or other factors. For example, FIG. 3 shows a change condition of a subscription conversion rate fluctuating with the Shanghai stock exchange composite index in a specific fund marketing short message delivery scenario. It may be learned from the figure that the subscription conversion rate of a user is highly consistent with a change trend of the Shanghai stock exchange composite index. This is because different users have different sensitivity to fluctuations of the market condition, time, or other factors (for example, in a case of a market decline, some users select bottom fishing, some users select stop loss, and some users tend to subscribe on trading days because fund shares cannot be determined on weekends and holidays), which may also result in differences in importance of different behaviors in historical behavior sequences of the users during estimation (for example, if a user tends to select bottom fishing in the case of the market decline, importance of a behavior corresponding to the market decline in a historical behavior sequence of the user is higher). The historical behavior sequence of the user is a sequence including behavior information, arranged based on a chronological order, of the user in a period of time, and corresponds to a historical interaction feature sequence. It may be learned that the market condition and time in the financial scenario are highly correlated with conversion of the user. The object processing method provided in this disclosure may be applied to the field of accurate marking in the financial scenario, to improve the conversion rate. For example, a user in the financial scenario is determined as a user object, and a fund is determined as a resource object. For example, a historical resource object and a target resource object may be the fund. The market condition and time are determined as dynamic influencing factors of the fund. Based on the object processing method provided in this disclosure, a conversion probability of the user in the financial scenario for the fund is obtained, and information about the fund is delivered to a user corresponding to a high conversion probability, for example, a fund marking short message is delivered. Therefore, the conversion rate is improved.

In some embodiments, the dynamic influencing factor includes at least one of the resource factor or the time factor. The resource factor is a resource factor that dynamically changes in a resource scenario. The operation of acquiring a historical status feature of a dynamic influencing factor of the historical resource object includes: determining an interaction moment at which the historical interaction feature is generated, and determining a time status feature corresponding to the time factor based on time information of the time factor at the interaction moment; acquiring resource information of the resource factor at the interaction moment, and determining a resource status feature corresponding to the resource factor based on the resource information; and determining the historical status feature based on at least one of the time status feature or the resource status feature.

The resource factor is a resource related factor. A resource value of the resource factor dynamically changes with time. The resource value is a value of a resource, for example, a price of the fund. The resource scenario is a scenario in which the resource is located. The resource scenario is, for example, the market, for example, at least one of a domestic market, a global market, or the like.

The interaction moment at which the historical interaction feature is generated is the foregoing interaction moment corresponding to the historical interaction feature. A status feature is a feature for reflecting a status. The time status feature is a status feature corresponding to the time factor, and is used for reflecting a status of the time factor. The resource status feature is a status feature corresponding to the resource factor, and is used for reflecting a status of the resource factor. The historical status feature may include at least one of the time status feature or the resource status feature.

Specifically, the server may acquire the time information of the time factor at the interaction moment corresponding to the historical interaction feature, and encode the time information to obtain the time status feature corresponding to the time factor at the interaction moment. The server may acquire the resource information of the resource factor at the interaction moment corresponding to the historical interaction feature, and encode the resource information to obtain the resource status feature corresponding to the resource factor at the interaction moment.

In some embodiments, the server may determine at least one of the time status feature or the resource status feature as the historical status feature. For example, the server may determine the time status feature as the historical status feature, determine the resource status feature as the historical status feature, or determine the time status feature and the resource status feature as the historical status feature.

In this embodiment, because the statuses of the time factor and the resource factor are highly correlated with the change of the resource attribute of the resource object, determining the historical status feature based on the time status feature corresponding to the time factor or the resource status feature corresponding to the resource factor may ensure that the historical status feature is more consistent with an actual situation. Therefore, the accuracy of the historical status feature is improved.

In some embodiments, the operation of determining a conversion prediction feature of the user object for a target resource object at current time based on the historical interaction feature and the historical status feature includes: determining a following degree feature of the user object for the target resource object at the current time based on the historical interaction feature and the historical status feature; and determining the conversion prediction feature of the user object for the target resource object at the current time based on the following degree feature.

The following degree feature is used for reflecting a following status of the user object for the target resource object. Because the following status of the user object for the target resource object greatly influences conversion of the user object for the target resource object, determining the conversion prediction feature of the user object based on the following degree feature of the user object may improve the accuracy of the conversion prediction feature.

Specifically, the server may perform feature fusion on the historical interaction feature and the historical status feature to obtain the following degree feature of the user object for the target resource object at the current time. When there are a plurality of historical interaction features, for each historical interaction feature, the server may determine an interaction moment corresponding to the historical interaction feature, acquire a historical status feature of a dynamic influencing factor of a historical resource object corresponding to the historical interaction feature at the interaction moment, and determine a following status feature of the user object for the target resource object at the interaction moment based on the historical interaction feature and the historical status feature. Because the historical interaction features correspond to different interaction moments, following status features of the user object for the target resource object at a plurality of interaction moments may be obtained. The server may perform feature fusion on the following status features at the interaction moments to obtain the following degree feature. For example, the server may determine a weight corresponding to each following status feature, perform weighted calculation on each following status feature based on the determined weight, and determine a weighted calculation result as the following degree feature. The following status feature at the interaction moment is used for reflecting a following status of the user object for the target resource object at the interaction moment.

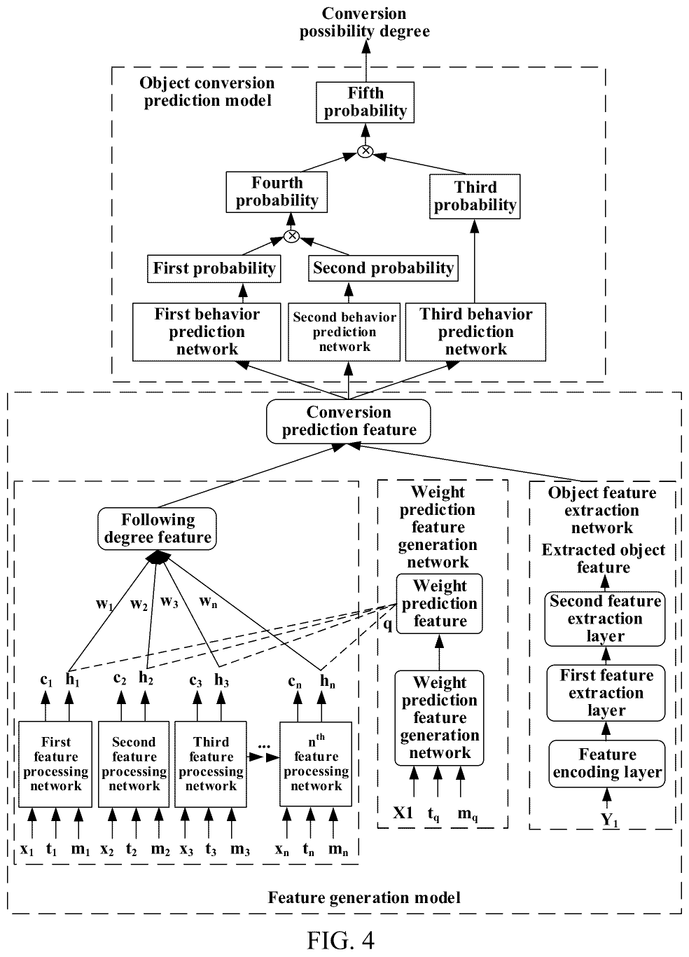

In some embodiments, the feature generation model may include a plurality of feature processing networks. The feature processing networks in the feature generation model may be connected. For example, output data of one feature processing network is input to another feature processing network. Each feature processing network corresponds to a connection sequence. Output data of a feature processing network corresponding to an early connection sequence is input to a feature processing network corresponding to a late connection sequence. FIG. 4 shows one feature generation model. The feature generation model includes n feature processing networks. The n feature processing networks are connected. Output data of the first feature processing network is input to the second feature processing network. Therefore, a connection sequence of the first feature processing network is early, and a connection sequence of the second feature processing network is later than that of the first feature processing network. The feature processing network is configured to generate a following status feature. Each feature processing network may be configured to generate a following status feature at one interaction moment. For example, for each interaction moment, the server may determine a feature processing network corresponding to the interaction moment, input a historical interaction feature corresponding to the interaction moment and a historical status feature corresponding to the interaction moment to the feature processing network corresponding to the interaction moment, and obtain a following status feature at the interaction moment by using the feature processing network. The feature processing network corresponding to the interaction moment may be determined based on the interaction moment. For example, if the interaction moment is earlier, a connection sequence of the feature processing network corresponding to the interaction moment is earlier. As shown in FIG. 4, T₁ to Tₙ denote n interaction moments, a moment Tⱼ₋₁ is a moment before a moment Tⱼ, and a feature processing network corresponding to the moment Tⱼ is a j^{th} feature processing network. x₁ to xₙ denote historical interaction features respectively corresponding to the interaction moments T₁ to Tₙ. For example, sⱼ denotes a historical interaction feature corresponding to Tⱼ. t₁ to tₙ denote time status features respectively corresponding to the interaction moments T₁ to Tₙ. For example, tⱼ denotes a time status feature corresponding to the moment Tⱼ. m₁ to mₙ denote resource status features respectively corresponding to the interaction moments T₁ to Tₙ. For example, mⱼ denotes a resource status feature corresponding to the moment Tⱼ. 1≤j≤n. A feature processing network is a custom structure, and may be a network obtained by improving an existing network, for example, a network obtained through improvement based on a long short-term memory (LSTM) neural network. When the feature processing network is obtained through improved based on the LSTM neural network, the feature processing network may also be referred to as a financial long short-term memory (FLSTM) neural network. Certainly, the feature processing network may be based on a transformer model.

In some embodiments, the server may determine the following degree feature of the user object for the target resource object at the current time as the conversion prediction feature of the user object for the target resource object at the current time.

In some embodiments, the server may acquire object information of the user object, encode the object information to obtain an encoded object feature of the user object, and obtain the conversion prediction feature based on the encoded object feature of the user object and the following degree feature. For example, the server may perform feature fusion, for example, feature concatenation processing, on the encoded object feature and the following degree feature, and determine a processing result as the conversion prediction feature. The object information may include attribute information of the user object, and may further include resource interaction information of the user object. The attribute information of the user object includes but is not limited to the age, the gender, an occupation, a region, and the like of the user object. The resource interaction information may include interaction information generated between the user object and the resource object before the current time, for example, may include interaction information of the user object within a specified time range before the current time. In this embodiment, the conversion prediction feature is obtained based on the object information of the user object and the following degree feature. Because the object information of the user object may reflect a feature of the user object, the conversion prediction feature is fused with the feature of the user object, and a representation capability of the conversion prediction feature is improved.

In some embodiments, the conversion prediction feature may include the following degree feature. The conversion prediction feature may further include a feature of the object. For example, the server may further perform feature extraction on the encoded object feature to obtain an extracted object feature, and concatenate the extracted object feature and the following degree feature to obtain the conversion prediction feature. Therefore, the conversion prediction feature includes the feature of the object. For example, the conversion prediction feature may be represented as share embedding=[act embedding, feature embedding], where share embedding represents the conversion prediction feature, act embedding represents the following degree feature, and feature embedding represents the extracted object feature.

In some embodiments, the feature generation model may further include an object feature extraction network. The object feature extraction network is configured to extract the extracted object feature. The object feature extraction network may use a fully connected neural network with any quantity of layers. A two-layer fully connected network is used as an example. FIG. 4 shows the object feature extraction network in the feature generation model. Y₁ denotes the object information. The object feature extraction network includes a feature encoding layer, a first feature extraction layer, and a second feature extraction layer. The first feature extraction layer and the second feature extraction layer each are a fully connected neural network. The feature encoding layer is configured to encode the object information to obtain the encoded object feature. The first feature extraction layer is configured to perform feature extraction on the encoded object feature to obtain a first extracted feature. The second feature extraction layer is configured to perform feature extraction on the first extracted feature to obtain the extracted object feature. For example, the feature embedding may be represented as feature embedding=σ(W₂O₁+b₂), O₁=σ(W₁Y₂+b₁). Y₂ represents the encoded object feature output by the feature encoding layer after encoding the object information Y₁. W₁ and b₁ represent parameters of the first feature extraction layer. W₂ and b₂ represent parameters of the second feature extraction layer. O₁ represents the first extracted feature obtained by the first feature extraction layer.

In this embodiment, because the following status of the user object for the target resource object greatly influences conversion of the user object for the target resource object, determining the conversion prediction feature of the user object based on the following degree feature of the user object improves the accuracy of the conversion prediction feature.

In some embodiments, there are a plurality of historical interaction features. Each historical interaction feature corresponds to an interaction moment. The interaction moment is a moment at which the historical interaction feature is generated. The historical status feature is a status feature of the dynamic influencing factor of the historical resource object at the interaction moment. The interaction moment is a moment within a preset time range before the current time. The operation of determining a following degree feature of the user object for the target resource object at the current time based on the historical interaction feature and the historical status feature includes: determining, for an interaction moment corresponding to each historical interaction feature, a previous moment of the interaction moment, and acquiring a following status feature of the user object at the previous moment to obtain a previous following status feature, the previous following status feature being used for representing a following status of the user object for the target resource object at the previous moment; processing an incremental feature based on the previous following status feature and the historical interaction feature at the interaction moment to obtain an incremental feature at the interaction moment, the incremental feature being an additional feature of the historical interaction feature relative to the previous following status feature; obtaining a following status feature at the interaction moment based on the historical interaction feature and a historical status feature at the interaction moment; and determining the following degree feature of the user object for the target resource object at the current time based on a following status feature at each interaction moment.

The interaction moment is a moment at which historical interaction data for obtaining the historical interaction feature is generated. The preset time range may be preset as required, for example, may be las three months or last six months. The interaction moment is a moment within the preset time range. The previous moment of the interaction moment is at least one of interaction moments before this interaction moment. For example, the previous moment of the interaction moment is an interaction moment that is before this interaction moment and closest to this moment. For example, the historical interaction feature sequence includes a plurality of historical interaction features, and the historical interaction features are arranged based on interaction moments. In this case, an interaction moment corresponding to a previous historical interaction feature is a previous moment of an interaction moment corresponding to a next historical interaction feature. For example, the historical interaction feature sequence is “a historical interaction feature corresponding to the moment T₁, a historical interaction feature corresponding to a moment T₂, and a historical interaction feature corresponding to a moment T₃”. Although both the moment T₁ and the moment T₂ are before the moment T₃, because the moment T₂ is closest to the moment T₃, the moment T₂ is a previous moment of the moment T₃. The following status feature is used for representing a following status of the user object for the target resource object. The incremental feature may reflect a new feature of the historical interaction feature at the interaction moment relative to the following status feature at the previous moment.

Specifically, the server may determine the preset time range, and acquire resource interaction information of the user object within the preset time range. The resource interaction information includes the historical interaction data of the user object generated at a plurality of moments within the preset time range. The moment at which the historical interaction data is generated is determined as the interaction moment. The historical interaction data is encoded to obtain the historical interaction feature at the interaction moment. Each historical interaction feature is arranged based on the interaction moment to obtain the historical interaction feature sequence. The historical interaction feature sequence is, for example, “x₁, x₂, x₃, . . . , xₙ”, an interaction moment corresponding to xⱼ is Tⱼ, and 1≤j≤n.

In some embodiments, for a historical interaction feature corresponding to each interaction moment in the historical interaction feature sequence, the server may determine a feature processing network corresponding to each interaction moment. When there is no previous moment for the interaction moment, for example, when the interaction moment is an interaction moment corresponding to the first historical interaction feature in the historical interaction feature sequence, the historical interaction feature and a historical status feature at the interaction moment are input to the feature processing network corresponding to the interaction moment to obtain a following status feature corresponding to the interaction moment. For example, an aggregate feature corresponding to the interaction moment is obtained first, and the following status feature at the interaction moment is generated based on the aggregate feature corresponding to the interaction moment. For example, in FIG. 4, the historical interaction feature sequence is “x₁, x₂, x₃, . . . , xₙ”, cⱼ denotes an aggregate feature at the moment Tⱼ, hⱼ denotes a following status feature at the moment Tⱼ, xⱼ denotes a historical interaction feature at the moment Tⱼ, tⱼ denotes a time status feature at the moment Tⱼ, and mⱼ denotes a resource status feature at the moment Tⱼ. For the moment T₁, x₁ denotes a historical interaction feature at the moment T₁, t₁ denotes a time status feature at the moment T₁, and m₁ denotes a resource status feature at the moment T₁. x₁, t₁, and m₁ are input to the first feature processing network to obtain an aggregate feature c₁ at the moment T₁, and a following status feature h₁ at the moment T₁ is obtained based on the aggregate feature c₁.

In some embodiments, there is a previous moment for the interaction moment. The server may acquire the previous moment of the interaction moment, acquire a following status feature at the previous moment to obtain a previous following status feature, concatenate the previous following status feature and the historical interaction feature at the interaction moment, perform a feature operation on a feature obtained through concatenation to obtain an incremental feature, and process the incremental feature based on the historical interaction feature and a historical status feature at the interaction moment to obtain a following status feature at the interaction moment. The following status feature may be obtained by using a feature processing network. In FIG. 4, the moment T₁ is a previous moment of the moment T₂, x₂ denotes a historical interaction feature at the moment T₂, t₂ denotes a time status feature at the moment T₂, and m₂ denotes a resource status feature at the moment T₂. A following status feature h₁ at the moment T₁ obtained by the first feature processing network is input to the second feature processing network, and x₂, t₂, and m₂ are input to the second feature processing network. The second feature processing network obtains an incremental feature at the moment T₂ based on the following status feature h₁ at the moment T₂ and x₂, and processes the incremental feature based on x₂, t₂, and m₂ to obtain a following status feature h₂ at the moment T₂.

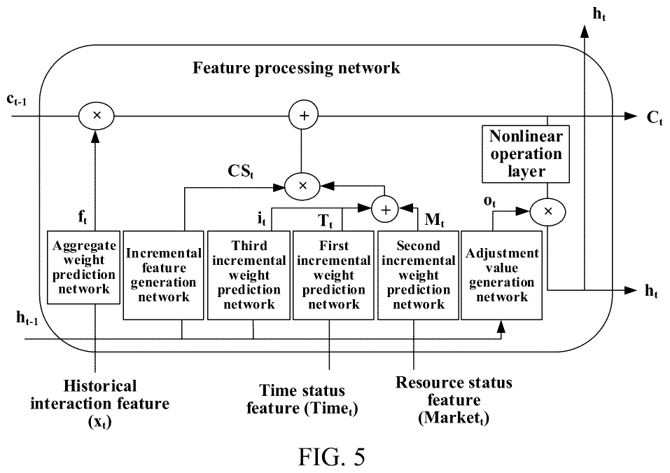

In some embodiments, the feature processing network may further include an incremental feature generation network. The incremental feature generation network is configured to generate the incremental feature. The server may concatenate the historical status feature at the interaction moment and the following status feature at the previous moment, input the concatenated feature to the incremental feature generation network, and perform a feature operation on the concatenated feature by using a parameter and an activation function of the incremental feature generation network to obtain the incremental feature at the interaction moment. FIG. 5 shows one feature processing network corresponding to a moment T. The feature processing network includes an incremental feature generation network. Input data of the incremental feature generation network includes a historical interaction feature xₜ at the moment T and a following status feature hₜ₋₁ at a moment T−1. An output of the incremental feature generation network is an incremental feature CSₜ at the moment T. For example, the incremental feature is CSₜ=tanh(W_{c}[hₜ₋₁, xₜ]+b_{c}). We and be represent parameters of the incremental feature generation network, and tanh is a hyperbolic tangent function, and is the activation function of the incremental feature generation network.

In this embodiment, because the previous following status feature is used for representing the following status of the user object for the target resource object at the previous moment, the incremental feature at the interaction moment is obtained based on the previous following status feature and the historical interaction feature at the interaction moment. The incremental feature is processed based on the historical interaction feature and the historical status feature at the interaction moment to obtain the following status feature at the interaction moment. The following degree feature of the user object for the target resource object at the current time is determined based on the following status feature at each interaction moment. Therefore, the following status of the user for the target resource object at the previous moment is involved in determining the following degree feature. Therefore, accuracy of the following degree feature is further improved.

In some embodiments, the operation of processing the incremental feature based on the historical interaction feature and a historical status feature at the interaction moment to obtain a following status feature at the interaction moment includes: acquiring an aggregate feature of the user object at the previous moment to obtain a previous aggregate feature; determining an incremental weight corresponding to the incremental feature based on the historical interaction feature and the historical status feature; determining an aggregate weight corresponding to the previous aggregate feature, and performing weighted calculation on the incremental feature and the previous aggregate feature based on the incremental weight and the aggregate weight to obtain an aggregate feature at the interaction moment; and determining the following status feature at the interaction moment based on the aggregate feature at the interaction moment.

When there is the previous moment for the interaction moment in the historical interaction feature sequence, the aggregate feature corresponding to the interaction moment may be calculated by using a manner of this embodiment. When there is no previous moment for the interaction moment in the historical interaction feature sequence, that is, the interaction moment is an interaction moment corresponding to the first historical interaction feature in the historical interaction feature sequence, the aggregate feature corresponding to the interaction moment is obtained based on the historical interaction feature and the historical status feature at the interaction moment.

Specifically, the server may concatenate the historical interaction feature at the interaction moment and the historical status feature at the interaction moment to obtain a historical concatenated feature, determine the incremental weight corresponding to the incremental feature based on the historical concatenated feature, and perform weighted calculation on the incremental feature and the previous aggregate feature based on the incremental weight and the aggregate weight to obtain the aggregate feature at the interaction moment. Obtaining the aggregate feature at the interaction moment through weighted calculation may determine, based on the weights, degrees that a feature in the aggregate feature at the interaction moment is derived from the previous aggregate feature and from the incremental feature. If the aggregate weight is higher, the degree of derivation from the previous aggregate feature is higher. If the incremental weight is higher, the degree of derivation from the incremental feature is higher. Therefore, the aggregate feature at the interaction moment is more consistent with the actual situation.

In some embodiments, the server may perform feature concatenation on the historical interaction feature at the interaction moment and the following status feature at the previous moment to obtain a first concatenated feature, and determine the incremental weight corresponding to the incremental feature based on the first concatenated feature and the historical concatenated feature.

In some embodiments, the server may determine the aggregate weight corresponding to the previous aggregate feature based on the following status feature at the previous moment and the historical interaction feature at the interaction moment. For example, the following status feature at the previous moment is concatenated with the historical interaction feature at the interaction moment to obtain the first concatenated feature, and a feature operation is performed on the first concatenated feature to obtain the aggregate weight corresponding to the previous aggregate feature.

In some embodiments, the server may process the aggregate feature at the interaction moment based on the following status feature at the previous moment and the historical interaction feature at the interaction moment to obtain the following status feature at the interaction moment. For example, the server may concatenate the following status feature at the previous moment and the historical interaction feature at the interaction moment to obtain the first concatenated feature, and process the aggregate feature at the interaction moment based on the first concatenated feature to obtain the following status feature at the interaction moment. For example, the feature operation is performed on the first concatenated feature to obtain a first concatenated feature after the feature operation, a nonlinear operation is performed on the aggregate feature at the interaction moment to obtain an aggregate feature after the nonlinear operation, and a product operation is performed on the first concatenated feature at the feature operation and the aggregate feature after the nonlinear operation to obtain the following status feature at the interaction moment.

In some embodiments, the aggregate feature at the interaction moment may be obtained by using the feature processing network. In FIG. 4, acquisition of an aggregate feature at the moment T₂ is used as an example. The first feature processing network inputs the obtained aggregate feature c₁ at the moment T₁ and the following status feature h₁ at the moment T₁ to the second feature processing network. The second feature processing network may determine an aggregate weight corresponding to c1 (that is, the previous aggregate feature) based on h₁ (that is, the following status feature at the previous moment) and x₂, and determine an incremental weight corresponding to the incremental feature based on x₂, t₂, and m₂, thereby obtaining the aggregate feature c₂ at the moment T₂ through weighted calculation.

In some embodiments, the following status feature at the interaction moment may also be obtained by using the feature processing network. For example, the feature processing network may perform the feature operation on the aggregate feature at the interaction moment to obtain the following status feature at the interaction moment. For example, the feature processing network may include an adjustment value generation network. The adjustment value generation network is configured to generate an aggregation adjustment value for adjusting the aggregate feature. The aggregation adjustment value may be generated based on the following status feature at the previous moment and the historical interaction feature at the interaction moment. For example, the following status feature at the previous moment and the historical interaction feature at the interaction moment are input to the adjustment value generation network to obtain the aggregation adjustment value corresponding to the aggregate feature at the interaction moment. FIG. 5 shows one feature processing network corresponding to the moment T. The feature processing network includes an adjustment value generation network. An input of the adjustment value generation network includes the historical interaction feature xₜ at the moment T and the following status feature at the moment T−1. An output of the adjustment value generation network is an aggregation adjustment value feature Oₜ. The aggregation adjustment value is Oₜ=σ(Wₒ[hₜ₋₁, xₜ]+bₒ). Wₒ and bₒ are parameters of the adjustment value generation network. [hₜ₋₁, xₜ] represents concatenating hₜ₋₁ and xₜ. The server may adjust the aggregate feature at the interaction moment by using the obtained aggregation adjustment value to obtain the following status feature at the interaction moment. Alternatively, the server may perform a nonlinear operation on the aggregate feature at the interaction moment, and adjust an aggregate feature after the nonlinear operation by using the aggregation adjustment value to obtain the following status feature at the interaction moment. As shown in FIG. 5, the feature processing network further includes a nonlinear operation layer. An input of the nonlinear operation layer is the aggregate feature cₜ at the moment T. An output result of the nonlinear operation layer, that is, an aggregate feature cₜ after the nonlinear operation and the aggregation adjustment value Oₜ, is input to a multiplication operation module. In FIG. 5, the circle with a “x” inside represents the multiplication operation module. The multiplication operation module is configured for feature multiplication. Feature multiplication is performed on the aggregate feature and the aggregation adjustment value by using the multiplication operation module to obtain the following status feature hₜ at the interaction moment. A dimension of the aggregation adjustment value may be the same as that of the aggregate feature. When the feature processing network in the feature generation network is an FLSTM neural network, Oₜ is an output gate in the LSTM neural network.

In this embodiment, because the incremental weight is determined based on the historical interaction feature and the historical status feature at the interaction moment, the incremental weight is more consistent with the actual situation. The aggregate feature reflects a remaining feature before the interaction moment. Therefore, performing weighted calculation on the incremental feature and the previous aggregate feature based on the incremental weight to obtain the aggregate feature at the interaction moment ensures that the aggregate feature at the interaction moment is a feature generated based on the feature at the interaction moment and a feature between interaction moments, and may not only inherit some features before the interaction moment but also include an additional feature at the interaction moment. Therefore, accuracy of the aggregate feature at the interaction moment is improved.

In some embodiments, the historical status feature includes at least one of a time status feature at the interaction moment or a resource status feature at the interaction moment. The operation of determining an incremental weight corresponding to the incremental feature based on the historical interaction feature and the historical status feature includes: obtaining a first weight corresponding to the incremental feature based on the historical interaction feature at the interaction moment and the time status feature at the interaction moment; obtaining a second weight corresponding to the incremental feature based on the historical interaction feature at the interaction moment and the resource status feature at the interaction moment; and determining the incremental weight corresponding to the incremental feature based on at least one of the first weight or the second weight.

Specifically, the server may concatenate the historical interaction feature at the interaction moment and the time status feature at the interaction moment to obtain a first historical concatenated feature, and concatenate the historical interaction feature at the interaction moment and the resource status feature at the interaction moment to obtain a second historical concatenated feature. The server may determine the incremental weight corresponding to the incremental feature based on at least one of the first historical concatenated feature or the second historical concatenated feature. For example, the server may determine the first weight corresponding to the incremental feature based on the first historical concatenated feature, determine the second weight corresponding to the incremental feature based on the second historical concatenated feature, and obtain the incremental weight corresponding to the incremental feature based on at least one of the first weight or the second weight. For example, the first weight is determined as the incremental weight. Alternatively, the second weight is determined as the incremental weight. Alternatively, an addition operation is performed on the first weight and the second weight, and an addition operation result is determined as the incremental weight.

In some embodiments, the server may determine a third weight corresponding to the incremental feature based on the first concatenated feature, and perform an addition operation on at least one of the first weight or the second weight and the third weight to obtain the incremental weight corresponding to the incremental feature. For example, the addition operation is performed on the first weight, the second weight, and the third weight, and an addition operation result is determined as the incremental weight corresponding to the incremental feature. Weighted calculation is performed by using the incremental weight to obtain the aggregate feature at the interaction moment. For example, the aggregate feature at the interaction moment is cₜ=fₜ*cₜ₋₁+(iₜ+Mₜ+Tₜ)*CSₜ. cₜ represents an aggregate feature at the interaction moment, that is, the moment T. cₜ₋₁ represents an aggregate feature at the previous moment, that is, the moment T−1. fₜ represents the aggregate weight corresponding to the previous aggregate feature. iₜ represents the third weight. Mₜ represents the second weight. Tₜ represents the first weight. CSₜ represents the incremental feature at the moment T. In FIG. 5, a module represented by a circle with a “+” inside is an addition module. The addition module is a module for the addition operation, that is, a summation operation. The first weight Tₜ, the second weight Mₜ, and the third weight iₜ are input to the addition module to perform summation to obtain (iₜ+Mₜ+Tₜ). (iₜ+Mₜ+Tₜ) and the incremental feature CSₜ at the moment T are input to the multiplication operation module to obtain (iₜ+Mₜ+Tₜ)*CSₜ. The aggregate weight fₜ corresponding to the aggregate feature cₜ₋₁ at the moment T−1 and the aggregate feature cₜ₋₁ at the moment T−1 are input to the multiplication operation module to obtain fₜ*cₜ₋₁. (iₜ+Mₜ+Tₜ)*CSₜ and fₜ*cₜ₋₁ are input to the addition module to obtain fₜ*cₜ₋₁+(iₜ+Mₜ+Tₜ)*CSₜ, that is, cₜ.

In some embodiments, the feature processing network in the feature generation network may be an FLSTM neural network. ft may also be a forget gate in the LSTM neural network, and is used for determining a degree of transmitting the previous state cₜ₋₁ forwards. iₜ may also be an input gate in the LSTM neural network, and determines a degree of introducing update information of t steps. When the resource factor is the market, Mₜ may be referred to as a market offset gate added based on the LSTM neural network, and Tₜ may be referred to as a time offset gate added based on the LSTM neural network.

In this embodiment, because the first weight is determined based on the historical interaction feature at the interaction moment and the time status feature at the interaction moment, and the second weight is determined based on the historical interaction feature at the interaction moment and the resource status feature at the interaction moment, the first weight is consistent with a time status, and the second weight is consistent with a resource status. That is, the first weight and the second weight are consistent with the actual situation. Therefore, determining the incremental weight corresponding to the incremental feature based on at least one of the first weight or the second weight ensures that the incremental weight is consistent with the actual situation, and improves the accuracy of the incremental weight.

In some embodiments, the following status feature is generated by inputting the historical interaction feature and the historical status feature to the feature processing network corresponding to the interaction moment. The feature processing network includes an incremental weight prediction network. The operation of determining an incremental weight corresponding to the incremental feature based on the historical interaction feature and the historical status feature includes: inputting the historical interaction feature and the historical status feature to the incremental weight prediction network to predictively obtain the incremental weight corresponding to the incremental feature.

Specifically, the server may input the historical interaction feature and the historical status feature to the incremental weight prediction network to predictively obtain the incremental weight corresponding to the incremental feature. When there are a plurality of historical status features, there may be a plurality of incremental weight prediction networks. For example, each historical status feature corresponds to an incremental weight prediction network. For each historical status feature, the server may input the historical status feature and a historical interaction feature to an incremental weight prediction network corresponding to the historical status feature to predictively obtain a weight corresponding to the historical status feature. An example in which the historical status feature includes the time status feature and the resource status feature is used. FIG. 5 shows one feature processing network corresponding to the moment T. The feature processing network includes a first incremental weight prediction network and a second incremental weight prediction network. The first incremental weight prediction network is an incremental weight prediction network corresponding to the time status feature. The second incremental weight prediction network is an incremental weight prediction network corresponding to the resource status feature. Input data of the feature processing network corresponding to the moment T includes the historical interaction feature xₜ at the moment T, a time status feature Timeₜ at the moment T, a resource status feature Marketₜ at the moment T, the aggregate feature cₜ₋₁ at the moment T−1, and the following status feature hₜ₋₁ at the moment T−1. Output data of the feature processing network corresponding to the moment T includes the aggregate feature cₜ at the moment T and the following status feature hₜ at the moment T. An input of the first incremental weight prediction network includes the historical interaction feature xₜ and the time status feature Timeₜ. An output result of the first incremental weight prediction network is the first weight Tₜ corresponding to the incremental feature at the moment T. An output result of the second incremental weight prediction network is the second weight Mₜ corresponding to the incremental feature at the moment T. For example, the first weight is Tₜ=σ(Wₜ[Timeₜ, xₜ]+bₜ), and the second weight is Mₜ=σ(Wₘ[Marketₜ, xₜ]+bₘ). Wₜ and bₜ represent parameters of the first incremental weight prediction network. Wₘ and bₘ represent parameters of the second incremental weight prediction network. [Timeₜ, xₜ] represents concatenating Timeₜ and xₜ. σ represents an activation function of the network. An activation function used for obtaining Mₜ and Tₜ may be tanh. Because a value range of an output result of the activation function tanh is [−1, +1], a positive or negative effect of the moment T and additional information (that is, the historical interaction feature) at the moment T brought by a duration factor may be reflected better. In some embodiments, the feature processing network further includes a third incremental weight prediction network. The third incremental weight prediction network is configured to predictively obtain the third weight corresponding to the incremental feature at the interaction moment based on the following status feature at the previous moment and the historical interaction feature at the interaction moment. As shown in FIG. 5, the feature processing network corresponding to the moment T includes a third incremental weight prediction network. Input data of the third incremental weight prediction network includes the historical interaction feature xₜ at the moment T and the following status feature hₜ₋₁ at the moment T−1. Output data of the third incremental weight prediction network is the third weight iₜ corresponding to the incremental feature at the moment T. For example, the third weight is iₜ=σ(Wᵢ[hₜ₋₁, xₜ]+bᵢ). Wᵢ and bᵢ represent parameters of the third incremental weight prediction network. σ represents an activation function of the network.

In this embodiment, the historical interaction feature and the historical status feature are input to the incremental weight prediction network to predictively obtain the incremental weight corresponding to the incremental feature. Therefore, the incremental weight may be predicted accurately and quickly, and the accuracy and prediction efficiency of the incremental weight are improved.

In some embodiments, the feature processing network further includes an aggregate weight prediction network. The operation of determining an aggregate weight corresponding to the previous aggregate feature includes: inputting the previous following status feature and the historical status feature at the interaction moment to the aggregate weight prediction network to predictively obtain the aggregate weight corresponding to the previous aggregate feature.

Specifically, the server may concatenate the previous following status feature and the historical status feature at the interaction moment, input a concatenated feature to the aggregate weight prediction network, and perform a feature operation on the concatenated feature by using a network parameter and an activation function of the aggregate weight prediction network to obtain the aggregate weight corresponding to the previous aggregate feature. As shown in FIG. 5, the feature processing network corresponding to the moment T includes an aggregate weight prediction network. An input of the aggregate weight prediction network includes the following status feature hₜ₋₁ at the moment T−1 and the historical interaction feature xₜ at the moment T. An output result is the aggregate weight fₜ corresponding to the aggregate feature cₜ₋₁ at the moment T−1. For example, the aggregate weight is fₜ=σ(W_{f}[hₜ₋₁, xₜ]+b_{f}). W_{f} and b_{f} represent parameters of the aggregate weight prediction network. σ represents the activation function.

A whole formed by each feature processing network in FIG. 5 may be referred to as a user behavior part, that is, a model configured to extract and represent a historical behavioral interest of the user. A weight prediction feature generation network may be referred to as a query part, that is, a module configured to generate a query vector in an attention mechanism. The object feature extraction network may be referred to as a deep neural network (DNN) part, that is, a module configured to extract and represent a feature of the user. The object conversion prediction model may also be referred to as an entire space multi-task part. The DNN is an abbreviation of deep neural network.

In this embodiment, the previous following status feature and the historical status feature at the interaction moment are input to the aggregate weight prediction network to obtain the aggregate weight corresponding to the previous aggregate feature. This improves the prediction efficiency and accuracy of the aggregate weight.

In some embodiments, the operation of determining the following degree feature of the user object for the target resource object at the current time based on a following status feature at each interaction moment includes: acquiring an object feature of the user object and a current status feature of a dynamic influencing factor of the target resource object at the current time; determining a weight corresponding to the following status feature at each interaction moment based on the object feature and the current status feature; and performing weighted calculation on each following status feature by using the weight corresponding to each following status feature to determine the following degree feature of the user object for the target resource object at the current time.

The current status feature is used for representing a status of the dynamic influencing factor of the target resource object at the current time. When the dynamic influencing factor includes a time factor, the current status feature includes a time status feature of the time factor at the current time. When the dynamic influencing factor includes a resource factor, the current status feature includes a resource status feature of the resource factor at the current time.

Specifically, the server may concatenate the object feature and the current status feature to obtain a second concatenated feature, and obtain a weight prediction feature based on the second concatenated feature. The weight prediction feature is used for predicting the weight corresponding to the following status feature at each interaction moment. The server may concatenate the time status feature at the current time, the resource status feature at the current time, and the object feature to obtain the second concatenated feature. The server may determine the second concatenated feature as the weight prediction feature, or perform a feature operation on the weight prediction feature to obtain the second concatenated feature. For the following status feature at each interaction moment, the server may perform weight prediction based on the weight prediction feature and the following status feature to obtain a weight corresponding to the following status feature. After the weight corresponding to each following status feature is acquired, weighted calculation is performed on each following status feature by using the weight to obtain the following degree feature of the user object for the target resource object at the current time.

In some embodiments, the feature generation model may further include the weight prediction feature generation network. The weight prediction feature generation network is configured to generate the weight prediction feature. The server may input the second concatenated feature to the weight prediction feature generation network to obtain the weight prediction feature. FIG. 4 shows the weight prediction feature generation network in the feature generation model. The time status feature at the current time is tq. The resource status feature at the current time is mq. The encoded object feature is X1. The second concatenated feature is [X1, tq, mq]. [X1, tq, mq] is input to the weight prediction feature generation network to obtain the weight prediction feature q (in the figure, q is the weight prediction feature). It is assumed that a weight parameter of the weight prediction feature generation network is Wq, an offset parameter is bq, and an activation function is σ. σ includes but is not limited to sigmoid, relu, or tanh. In this case, the weight prediction feature is q=σ(Wq[tq, mq, X1]+bq).

In some embodiments, the weight corresponding to each following status feature may be calculated by using the attention mechanism. For example, the weight corresponding to each following status feature may be calculated by using the following formula. Wₐ represents a model of a network used by the attention mechanism. σ represents an activation function of the network. eᵢ represents a result calculated by using the attention mechanism. eᵢ is a result obtained by performing attention calculation on an i^{th} following status feature and the weight prediction feature. Each attention calculation result is normalized to obtain the weight. αᵢ represents a weight corresponding to the i^{th} following status feature.

$${e}_{i} = σ ( {W}_{a} [ q , {h}_{i} ] ) , {α}_{i} = \frac{exp ( {e}_{i} )}{{\sum }_{i = 1}^{n} exp ( {e}_{i} )}$$

In some embodiments, after the weight corresponding to each following status feature is obtained, weighted calculation is performed on each following status feature to obtain the following degree feature. For example, the following degree feature may be represented as:
act embedding=Σᵢ₌₁ⁿαᵢhᵢ, where act embedding represents the following degree feature.

In this embodiment, the weight corresponding to the following status feature is determined based on the object feature and the current status feature of the dynamic influencing factor of the target resource object at the current time, so that the calculated weight is consistent with the feature of the object and the status of the dynamic influencing factor at the current time, and the weight is more authentic and reliable.

In some embodiments, the operation of predicting a conversion possibility degree of the user object for the target resource object at the current time based on the conversion prediction feature includes: acquiring a conversion link corresponding to the target resource object, the conversion link including an interactive behavior required to be performed by the user object during conversion for the target resource object; predicting, based on the conversion prediction feature for each interactive behavior in the conversion link, a possibility degree of occurrence of the interactive behavior of the user object for the target resource object, to obtain a behavior occurrence possibility degree corresponding to the interactive behavior; and obtaining the conversion possibility degree of the user object for the target resource object at the current time based on each behavior occurrence possibility degree, the conversion possibility degree being in positive correlation with the behavior occurrence possibility degree.

When there is no previous behavior for the interactive behavior in the conversion link, the behavior occurrence possibility degree corresponding to the interactive behavior is used for representing a probability of occurrence of the interactive behavior of the user object for the target resource object. When there is a previous behavior for the interactive behavior in the conversion link, the behavior occurrence possibility degree corresponding to the interactive behavior is used for representing a probability of occurrence of the interactive behavior of the user object for the target resource object in a case of occurrence of the previous behavior of the user object for the target resource object. If the behavior occurrence possibility degree is higher, the probability of occurrence of the interactive behavior is higher. The previous behavior of the interactive behavior is an interactive behavior arranged before the interactive behavior in the conversion link. For example, the conversion link is “visit [symbol] click [symbol] subscription”. In this case, a previous behavior of “subscription” includes “visit” and “click”. The behavior possibility degree corresponding to the interactive behavior may be used for representing a possibility degree of occurrence of the interactive behavior of the user object for the target resource object at the current time.

Specifically, the server may acquire the trained object conversion prediction model. The object conversion prediction model is configured to predict the conversion possibility degree. The object conversion prediction model may include a behavior prediction network corresponding to each interactive behavior in the conversion link. The behavior prediction network corresponding to the interactive behavior is configured to predict a behavior occurrence possibility degree corresponding to the interactive behavior. The server may input the conversion prediction feature to each behavior prediction network to predictively obtain the behavior occurrence possibility degree corresponding to each interactive behavior. An example in which the conversion link is “visit [symbol] click [symbol] subscription” is used. FIG. 4 shows the object conversion prediction model. The object conversion prediction model includes three behavior prediction networks. The first behavior prediction network is a behavior prediction network corresponding to “visit”, and predictively obtains a probability of occurrence of “visit”. The second behavior prediction network is a behavior prediction network corresponding to “click”, and predictively obtains a probability of occurrence of “click” in a case of occurrence of “visit”. The third behavior prediction network is a behavior prediction network corresponding to “subscription”, and predictively obtains a probability of occurrence of “subscription” in a case of occurrence of “visit” and “click”.

In some embodiments, the conversion possibility degree is in positive correlation with the behavior occurrence possibility degree. The server may perform a multiplication operation on the behavior occurrence possibility degree corresponding to each interactive behavior, and determine a multiplication operation result as the conversion possibility degree of the user object for the target resource object at the current time. As shown in FIG. 4, the first behavior prediction network outputs a first probability. The second behavior prediction network outputs a second probability. The third behavior prediction network outputs a third probability. The first probability is multiplied by the second probability to obtain a fourth probability. The fourth probability is multiplied by the third probability to obtain a fifth probability. The fifth probability is determined as the conversion possibility degree. The example in which the conversion link is “visit [symbol] click [symbol] subscription” is used. In this case, the first probability is the probability of occurrence of “visit” of the user object, the second probability is the probability of occurrence of “click” in the case of occurrence of “visit” of the user object, and the third probability is the probability of occurrence of “subscription” in the case of occurrence of “visit” and “click” of the user object. The three probabilities are multiplied to obtain a probability of conversion of the user, that is, the probability of occurrence of subscription of the user.

The positive correlation means that in a case that other conditions remain unchanged, two variables change in a same direction, and when one variable decreases, the other variable also decreases. It may be understood that the positive correlation herein means that change directions are consistent, but does not require the other variable to change when one variable changes a little. For example, it may be set that a variable b is 100 when a variable a changes from 10 to 20, and the variable b is 120 when the variable a changes 20 to 30. In this case, both a and b change in a direction that b increases when a increases. However, b may remain unchanged when a ranges from 10 to 20.

In this embodiment, the conversion possibility degree of the user object for the target resource object at the current time is obtained based on each behavior occurrence possibility degree. Because the conversion possibility degree is in positive correlation with the behavior occurrence possibility degree, the accuracy of the conversion possibility degree is improved.

In some embodiments, the operation of predicting, based on the conversion prediction feature for each interactive behavior in the conversion link, a possibility degree of occurrence of the interactive behavior of the user object for the target resource object, to obtain a behavior occurrence possibility degree corresponding to the interactive behavior includes: acquiring the previous behavior of the interactive behavior from the conversion link; and predicting, based on the conversion prediction feature, the possibility degree of occurrence of the interactive behavior of the user object for the target resource object in a case of occurrence of the previous behavior of the user object, to obtain the behavior occurrence possibility degree corresponding to the interactive behavior.

“The case of occurrence of the previous behavior” is the foregoing “case of occurrence of the previous behavior of the user object for the target resource object”.

In this embodiment, the possibility degree of occurrence of the interactive behavior of the user object for the target resource object in a case of occurrence of the previous behavior of the user object is predicted based on the conversion prediction feature to obtain the behavior occurrence possibility degree corresponding to the interactive behavior. This improves efficiency and accuracy of obtaining the behavior occurrence possibility degree.

In some embodiments, the operation of predicting, based on the conversion prediction feature for each interactive behavior in the conversion link, a possibility degree of occurrence of the interactive behavior of the user object for the target resource object, to obtain a behavior occurrence possibility degree corresponding to the interactive behavior includes: acquiring the trained object conversion prediction model, the object conversion prediction model including the behavior prediction network corresponding to each interactive behavior in the conversion link, and the behavior prediction network corresponding to the interactive behavior being configured to predict the behavior occurrence possibility degree corresponding to the interactive behavior; and inputting the conversion prediction feature to the behavior prediction network corresponding to each interactive behavior to predictively obtain the behavior occurrence possibility degree corresponding to each interactive behavior.

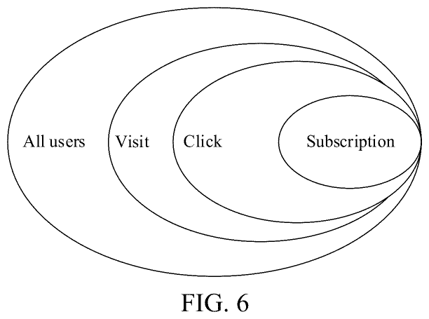

Specifically, the trained object conversion prediction model may be obtained through the following process. A sample user object set is acquired. The sample user object set includes a plurality of sample user objects. The sample user object is a user object for training the object conversion prediction model. An interactive behavior of each sample user object in the sample user object set for the target resource object within preset duration is determined. The preset duration may be, for example, a period of time after delivery marketing to the sample user object in the sample user object set, for example, one month or three months after delivery. After delivery, the sample user object may perform a behavior in a conversion link. For example, the user may perform three behaviors of visit, click, and conversion during conversion. FIG. 6 shows a sample space of a full scenario.

A sample label corresponding to each sample user object is determined based on the interactive behavior. Each sample user object may correspond to a plurality of sample labels. For example, a quantity of sample labels is the same as that of interactive behaves in the conversion link. An example in which the conversion link is “visit [symbol] click [symbol] subscription (that is, conversion)” is used for description. Three sample labels are included, for example, F1, F2, and F3. F1 represents a probability of occurrence of “visit” of the sample user object. F2 represents a probability of occurrence of “visit” and “click” of the sample user object. F3 represents a probability of occurrence of “visit”, “click”, and “subscription” of the sample user object. When the sample label is determined, the sample label is determined based on the interactive behavior of the sample user object within the preset duration. V∈{0,1} represents “visit”. V=1 represents a visit of the user. V=0 represents no visit of the user. Y∈{0,1} represents “click”. Y=1 represents a click of the user. Y=0 represents no click of the user. Z∈{0,1} represents “conversion (subscription)”. Z=1 represents conversion of the user. Z=0 represents no conversion of the user. If there is “V=1, Y=0, Z=0” for a sample user object A, it indicates occurrence of only “visit” of the sample user object A, and it is determined that sample labels of the sample user object A are “F1=1, F2=0, F3=0”. If there is “V=1, Y=1, Z=0” for a sample user object B, it indicates occurrence of “visit” and “click” of the sample user object B, and it is determined that sample labels of the sample user object B are “F1=1, F2=1, F3=0”. If there is “V=1, Y=1, Z=1” for a sample user object C, it indicates occurrence of “visit”, “click”, and “subscription” of the sample user object C, and it is determined that sample labels of the sample user object C are “F1=1, F2=1, F3=1”.

After the sample label corresponding to each sample user object in the sample user object set is determined, a conversion prediction feature corresponding to the sample user object is acquired. The conversion prediction feature may be generated by using the feature generation model. The conversion prediction feature corresponding to the sample user object is input to each behavior prediction network, for example, input to a behavior prediction network corresponding to “visit”, a behavior prediction network corresponding to “click”, and a behavior prediction network corresponding to “subscription”, to obtain a first predicted probability of occurrence of “visit” of the sample user object, that is, pvisit=p(V=1|X), a second predicted probability of occurrence of “click” on the premise of occurrence of “visit”, that is, pctr=p(Y=1|V=1, X), and a third predicted probability of occurrence of “subscription” on the premise of occurrence of “visit” and “click”, that is, pcvr=p(Z=1|Y=1, V=1, X). X is used for representing a sample user object, for example, may be an object feature of the sample user object. The first predicted probability is multiplied by the second predicted probability to obtain a fourth predicted probability pvisit−ctr=p(Y&V=1|X)=p(Y=1|V=1, X)*p(V=1|X). The fourth predicted probability represents a probability of occurrence of “click” and “visit” of the sample user object. The third predicted probability is multiplied by the fourth predicted probability to obtain a fifth predicted probability pvisit−ctcvr=p(Z&Y&V=1|X)=p(Z=1|Y=1, V=1, X)*p(Y&V=1|X). A model loss value corresponding to the object conversion prediction model is generated based on the first predicted probability, the fourth predicted probability, the fifth predicted probability, and the sample label. Each behavior prediction network in the object conversion prediction model is adjusted by using the model loss value. When the model converges, the trained object conversion prediction model is obtained. A sample label corresponding to the first predicted probability is F1. A sample label corresponding to the fourth predicted probability is F2. A sample label corresponding to the fifth predicted probability is F3. The model loss value L may be represented by using the following formula:

L=Σᵢ₌₁ⁿl(V,pvisit)+Σᵢ₌₁ⁿl(V&Y,pvisit*pctr)+Σᵢ₌₁ⁿl(V&Y&Z,pvisit*pctr*pcVr).

In the formula, V represents that the sample label is F1. V&Y represents that the sample label is F2. V&Y&Z represents that the sample label is F3. n represents a quantity of sample user objects used in one training session. pvisit represents a visitor rate, for example, represents a visitor rate after marketing delivery. The visitor rate is used for representing a ratio of a quantity of visitors to a quantity of persons that information is delivered to. pctr represents a click-through rate. The click-through rate is used for representing a ratio of a quantity of clicks to the quantity of visitors. pcvr represents a conversion rate for representing a ratio of a quantity of converted persons to the quantity of clicks.

When the object conversion prediction model is trained, the sample user object may be a user in any conversion phase, for example, a user who does not “visits”, a user who only “visits”, a user who “visits” and “clicks”, or a user who “visits”, “clicks”, and “subscribes”. That is, all users are used in training. The training method has a low requirement on a training sample, and highly rich samples are used. This improves model training accuracy, and the method may be applied to a scenario in which there are few feature samples, for example, the financial scenario, to improve accuracy of predicting the conversion rate in the financial scenario. In the financial scenario, decision-making costs of the user are high, a behavior frequency is lower than those in scenarios of advertising, recommendation, and the like, there are fewer deeply converted samples, and different behaviors are often associated and progressive. For example, for in-site advertising of a financial management product, the user first needs to visit, may click if interested in delivered content after visiting, and may subscribe if accepting the product after clicking. The delivery, visit, click, and subscription behaviors are progressive layer by layer, but the final subscription behavior is often sparse, which brings a great challenge to modeling. If sample training is performed by using only users who subscribe, sample sparsity may lead to low model training accuracy. When the training method and the object conversion prediction model in this embodiment of this disclosure are applied to the financial scenario, any user in the financial scenario may be used as a sample. Therefore, the quantity and the richness of samples are improved, and the model training accuracy is improved.

In this embodiment, the behavior occurrence possibility degree corresponding to each interactive behavior is obtained by using each behavior prediction network in the object conversion prediction model. This improves the efficiency and accuracy of obtaining the behavior occurrence possibility degree.

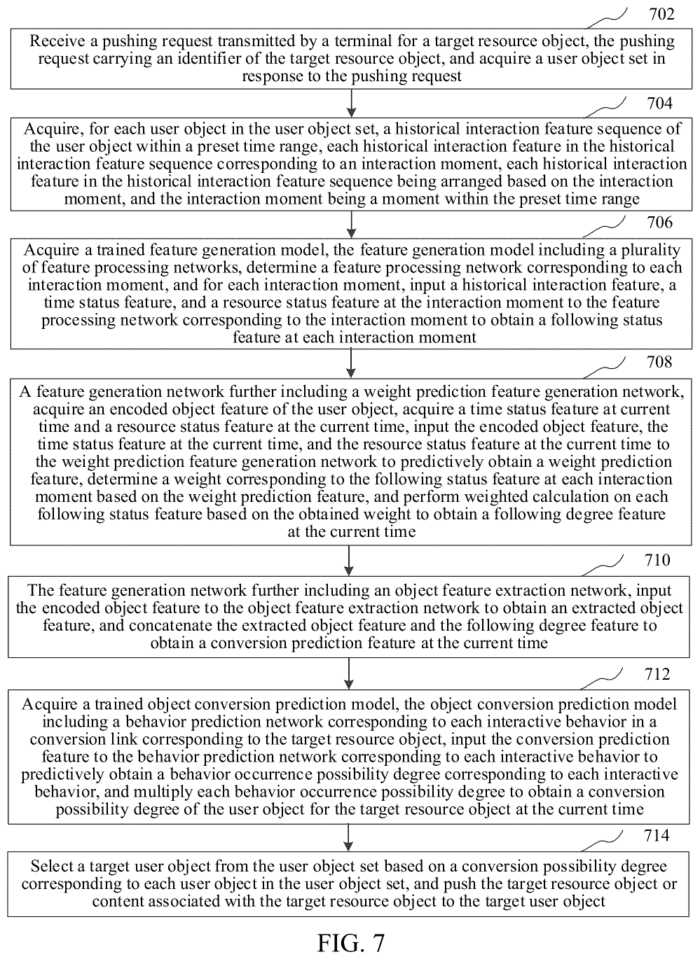

This disclosure also provides an application scenario. The foregoing object processing method is applied to the application scenario. Specifically, the application scenario is a financial scenario. The resource object is a resource object in the financial scenario, for example, may be a fund. As shown in FIG. 7, the object processing method is applied to the application scenario as follows.

Step 702: Receive a pushing request transmitted by the terminal for a target resource object, the pushing request carrying an identifier of the target resource object, and acquire a user object set in response to the pushing request.

Step 704: Acquire, for each user object in the user object set, a historical interaction feature sequence of the user object within a preset time range, each historical interaction feature in the historical interaction feature sequence corresponding to an interaction moment, each historical interaction feature in the historical interaction feature sequence being arranged based on the interaction moment, and the interaction moment being a moment within the preset time range.

A historical interaction feature corresponding to an earlier interaction moment has a higher ranking in the historical interaction feature sequence. Each historical interaction feature corresponds to a resource object. Resource objects corresponding to different historical interaction features may be the same or different.

Step 704: Acquire, for each interaction moment, a time status feature at the interaction moment, and acquire a resource status feature at the interaction moment, the resource status feature being used for representing a status of a resource factor of a resource object corresponding to a historical interaction feature corresponding to the interaction moment at the interaction moment.

For different resource objects, resource factors of resources may be the same or different. For example, historical interaction features of a user are item 1, item 2, and item 3 that correspond to interaction moments T₁, T₂, and T₃. In this case, time status features at the interaction moments are respectively time features corresponding to the moments T₁, T₂, and T₃, and resource status features at the interaction moments are respectively features of resource factors, for example, market conditions, corresponding to the moments T₁, T₂, and T₃.

To avoid data leakage and ensure consistency of value logics during training and prediction, an appropriate time offset may be set for the resource status feature, for example, the feature of the market condition, based on an actual situation. For example, a used resource status feature is a change of a closing price on a day T, and it is predicted that the market is yet not closed on that day and the closing price on the day T cannot be acquired. In this case, a closing price on a day T−1 (that is, with a one-day offset) may be used in training, thereby ensuring that there may be data of the same logic (the closing price on the day T−1) in prediction.

Step 706: Acquire a trained feature generation model, the feature generation model including a plurality of feature processing networks, determine a feature processing network corresponding to each interaction moment, and for each interaction moment, input a historical interaction feature, a time status feature, and a resource status feature at the interaction moment to the feature processing network corresponding to the interaction moment to obtain a following status feature at each interaction moment.

Step 708: A feature generation network further including a weight prediction feature generation network, acquire an encoded object feature of the user object, acquire a time status feature at current time and a resource status feature at the current time, input the encoded object feature, the time status feature at the current time, and the resource status feature at the current time to the weight prediction feature generation network to predictively obtain a weight prediction feature, determine a weight corresponding to the following status feature at each interaction moment based on the weight prediction feature, and perform weighted calculation on each following status feature based on the obtained weight to obtain a following degree feature at the current time.

The resource status feature at the current time is used for representing a status of a resource factor of the target resource object at the current time.

Step 710: The feature generation network further including an object feature extraction network, input the encoded object feature to the object feature extraction network to obtain an extracted object feature, and concatenate the extracted object feature and the following degree feature to obtain a conversion prediction feature at the current time.

Step 712: Acquire a trained object conversion prediction model, the object conversion prediction model including a behavior prediction network corresponding to each interactive behavior in a conversion link corresponding to the target resource object, input the conversion prediction feature to the behavior prediction network corresponding to each interactive behavior to predictively obtain a behavior occurrence possibility degree corresponding to each interactive behavior, and multiply each behavior occurrence possibility degree to obtain a conversion possibility degree of the user object for the target resource object at the current time.

Step 714: Select a target user object from the user object set based on a conversion possibility degree corresponding to each user object in the user object set, and push the target resource object or content associated with the target resource object to the target user object.

The server may compare the conversion possibility degree with a possibility degree threshold, and determine the user object as the target user object when determining that the conversion possibility degree is greater than the possibility degree threshold. The server may arrange each user object in the user object set based on the conversion possibility degree, for example, arrange the user objects in order from high to low conversion possibility degrees, to obtain a user object sequence. A user object corresponding to a higher conversion possibility degree has a higher ranking in the user object sequence. The server may acquire a user object whose ranking is before a ranking threshold in the user object sequence as the target user object. The possibility degree threshold and the ranking threshold may be preset or set as required. The content associated with the target resource object may be content for motivating the user to purchase the target resource object. For example, when the target resource object is a fun, the content may be a coupon of the fund.

In this embodiment, the conversion prediction feature is predictively obtained by using the time status feature and the resource status feature, so that authenticity and reliability of the conversion prediction feature are improved. The conversion possibility degree is determined by using each behavior prediction network in the object conversion prediction model, so that efficiency and accuracy of calculating the conversion possibility degree are improved.

In the embodiments of this disclosure, the object conversion prediction model and the feature generation model are combined. Because the object conversion prediction model may be obtained through training with all samples, and the object conversion prediction model includes a plurality of behavior prediction networks, an entire space multi-task model (ESMM) is implemented. In addition, the feature generation model may be an FLSTM neural network. Therefore, combination of the two models implements a neural network integrating an FLSTM and entire space multi-task learning.

Test results show that good effects may be achieved when the object processing method provided in this disclosure is applied to the financial scenario. Table 2 shows effects achieved when the object processing method provided in this disclosure is applied to the financial scenario. In Table 2, statistical distribution analysis results in this test show that the historical interaction feature sequence is constructed based on 16 funds that users click, subscribe for, and search for in last 30 days, and a feature (for example, a return, a lock-in period, or a maximum drawdown) of each fund product is used as a representation of the fund. If a length of the historical interaction feature sequence of the user is less than 16, the historical interaction feature sequence is supplemented with all-0 features. If a length of the historical interaction feature sequence of the user exceeds 16, the historical interaction feature sequence is truncated to 16 based on a chronological order.

TABLE 2
Online delivery effects

| | | | Quantity | |
|---|---|---|---|---|
| | | | of persons | |
| | | | converted | |
| | | | per | |
| Model | Conversion | Relative | thousand | Relative |
| name | AUC | improvement | deliveries | improvement |
| DNN | 0.9011 | — | 10.57 | — |
| ESMM | 0.9149 | 1.53% | 10.82 | 2.37% |
| LSTM | 0.9252 | 2.67% | 11.57 | 9.46% |
| FLSTM | 0.9301 | 3.22% | 13.45 | 27.2% |
| MFLSTM | 0.9382 | 4.12% | 15.53 | 46.9% |

In Table 2, the quantity of persons converted per thousand deliveries is pvisit−ctcvr*1000. The DNN model is an ordinary fully connected neural network that takes only whether to convert after delivery as a modeling objective. The ESMM is an ESMM-structured neural network with two objectives of click and conversion. The LSTM is added with an LSTM unit based on the ESMM to model historical interests of users. The FLTSM model includes an FLSTM unit instead of the LSTM unit. The multi-task FLSTM (MFLSTM) is a model that considers three objectives of visit, click, and conversion and that introduces an FLSTM to extract historical interests of users. It may be learned that compared with an original LSTM structure, the FLSTM may make an improvement of 16.2%; compared with the FLSTM, introduction of the objective of visit for entire space modeling may make an improvement of 15.5%; and compared with the baseline DNN model, an online improvement of 46.9% is finally made.

In this disclosure, the feature generation model may be based on a transformer model. For example, a user behavior sequence within a long time (for example, last six months) may be introduced, and the structure is optimized for particularity of the financial scenario. For example, factors such as time and the market condition in the financial scenario are represented as embedding, and are directly concatenated with sequence element representation features, or are fused with sequence element representation features as structures like position embedding for addition to a transformer structure, thereby predicting the conversion prediction feature of the user.

It is to be understood that, although each step in the flowchart in each of the foregoing embodiments is sequentially presented according to indications of arrowheads, these steps are not necessarily performed according to sequences indicated by the arrowheads. Unless otherwise explicitly specified herein, execution of the steps is not strictly limited, and the steps may be performed in other sequences. Moreover, at least some steps in each of the foregoing embodiments may include a plurality of sub-steps or a plurality of stages. The sub-steps or stages are not necessarily performed at the same time, and may be performed at different time. The sub-steps or stages are not necessarily performed in order, and may be performed in turn or alternately with other steps or at least some sub-steps or stages of other steps.

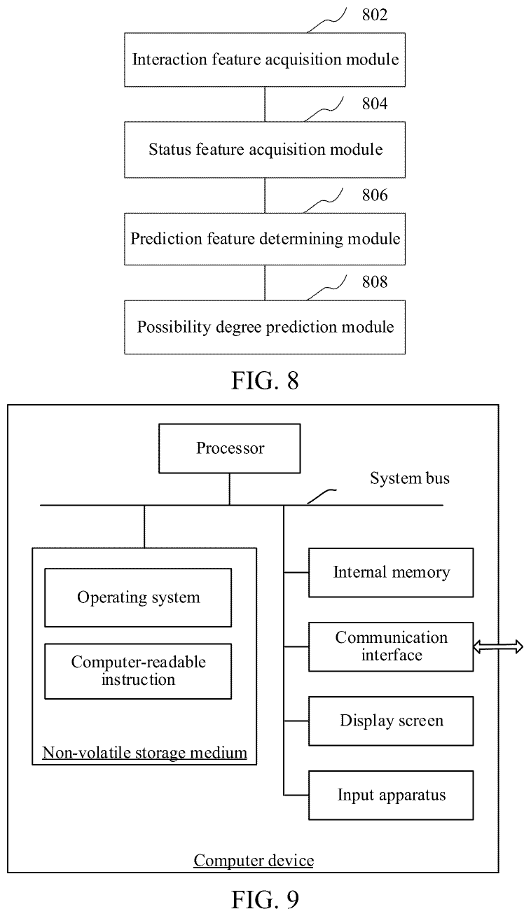

In some embodiments, as shown in FIG. 8, an object processing apparatus is provided. The apparatus may be implemented as a part of a computer device by using a software module, a hardware module, or a combination thereof. The apparatus specifically includes an interaction feature acquisition module 802, a status feature acquisition module 804, a prediction feature determining module 806, and a possibility degree prediction module 808.

The interaction feature acquisition module 802 is configured to acquire a historical interaction feature of a user object for a historical resource object.

The status feature acquisition module 804 is configured to acquire a historical status feature of a dynamic influencing factor of the historical resource object. The dynamic influencing factor is used for dynamically influencing a change of a resource attribute of the historical resource object. The historical status feature is determined based on historical status information of the dynamic influencing factor.

The prediction feature determining module 806 is configured to determine a conversion prediction feature of the user object for a target resource object at current time based on the historical interaction feature and the historical status feature.

The possibility degree prediction module 808 is configured to predict a conversion possibility degree of the user object for the target resource object at the current time based on the conversion prediction feature, to determine a processing manner for the user object for the target resource object based on the conversion possibility degree.

In some embodiments, the dynamic influencing factor includes at least one of the resource factor or the time factor. The resource factor is a resource factor that dynamically changes in a resource scenario. The status feature acquisition module is further configured to: determine an interaction moment at which the historical interaction feature is generated, and determine a time status feature corresponding to the time factor based on time information of the time factor at the interaction moment; acquire resource information of the resource factor at the interaction moment, and determine a resource status feature corresponding to the resource factor based on the resource information; and determine the historical status feature based on at least one of the time status feature or the resource status feature.

In some embodiments, the prediction feature determining module is further configured to: determine a following degree feature of the user object for the target resource object at the current time based on the historical interaction feature and the historical status feature; and determine the conversion prediction feature of the user object for the target resource object at the current time based on the following degree feature.

In some embodiments, the prediction feature determining module is further configured to: determine, for an interaction moment corresponding to each historical interaction feature, a previous moment of the interaction moment, the interaction moment corresponding to the historical interaction feature being a moment at which historical interaction data for obtaining the historical interaction feature is generated; acquire a following status feature of the user object at the previous moment to obtain a previous following status feature, the previous following status feature being used for representing a following status of the user object for the target resource object at the previous moment; obtain an incremental feature at the interaction moment based on the previous following status feature and the historical interaction feature at the interaction moment, the incremental feature being an additional feature of the historical interaction feature relative to the previous following status feature; process the incremental feature based on the historical interaction feature and a historical status feature at the interaction moment to obtain a following status feature at the interaction moment, the historical status feature at the interaction moment being a status feature of the dynamic influencing factor of the historical resource object at the interaction moment; and determine the following degree feature of the user object for the target resource object at the current time based on a following status feature at each interaction moment.

In some embodiments, the prediction feature determining module is further configured to: acquire an aggregate feature of the user object at the previous moment to obtain a previous aggregate feature; determine an incremental weight corresponding to the incremental feature based on the historical interaction feature and the historical status feature; determine an aggregate weight corresponding to the previous aggregate feature, and perform weighted calculation on the incremental feature and the previous aggregate feature based on the incremental weight and the aggregate weight to obtain an aggregate feature at the interaction moment; and determine the following status feature at the interaction moment based on the aggregate feature at the interaction moment.

In some embodiments, the historical status feature includes at least one of a time status feature at the interaction moment or a resource status feature at the interaction moment. The prediction feature determining module is further configured to: obtain a first weight corresponding to the incremental feature based on the historical interaction feature at the interaction moment and the time status feature at the interaction moment; obtain a second weight corresponding to the incremental feature based on the historical interaction feature at the interaction moment and the resource status feature at the interaction moment; and determine the incremental weight corresponding to the incremental feature based on at least one of the first weight or the second weight.

In some embodiments, the following status feature is generated by inputting the historical interaction feature and the historical status feature to a feature processing network corresponding to the interaction moment. The feature processing network includes an incremental weight prediction network. The prediction feature determining module is further configured to input the historical interaction feature and the historical status feature to the incremental weight prediction network to predictively obtain the incremental weight corresponding to the incremental feature.

In some embodiments, the feature processing network further includes an aggregate weight prediction network. The prediction feature determining module is further configured to input the previous following status feature and the historical status feature at the interaction moment to the aggregate weight prediction network to predictively obtain the aggregate weight corresponding to the previous aggregate feature.

In some embodiments, the prediction feature determining module is further configured to: acquire an object feature of the user object and a current status feature of a dynamic influencing factor of the target resource object at the current time; determine a weight corresponding to the following status feature at each interaction moment based on the object feature and the current status feature; and perform weighted calculation on each following status feature by using the weight corresponding to each following status feature to determine the following degree feature of the user object for the target resource object at the current time.

In some embodiments, the prediction feature determining module is further configured to: obtain object information of the user object; encode the object information to obtain an encoded object feature of the user object; and obtain the conversion prediction feature of the user object for the target resource object at the current time based on the encoded object feature of the user object and the following degree feature.

In some embodiments, the possibility degree prediction module is further configured to: acquire a conversion link corresponding to the target resource object, the conversion link including an interactive behavior required to be performed by the user object during conversion for the target resource object; predict, based on the conversion prediction feature for each interactive behavior in the conversion link, a possibility degree of occurrence of the interactive behavior of the user object for the target resource object, to obtain a behavior occurrence possibility degree corresponding to the interactive behavior; and obtain the conversion possibility degree of the user object for the target resource object at the current time based on each behavior occurrence possibility degree, the conversion possibility degree being in positive correlation with the behavior occurrence possibility degree.

In some embodiments, the possibility degree prediction module is further configured to: acquire the previous behavior of the interactive behavior from the conversion link; and predict, based on the conversion prediction feature, the possibility degree of occurrence of the interactive behavior of the user object for the target resource object in a case of occurrence of the previous behavior of the user object, to obtain the behavior occurrence possibility degree corresponding to the interactive behavior.

In some embodiments, the possibility degree prediction module is further configured to: acquire a trained object conversion prediction model, the object conversion prediction model including a behavior prediction network corresponding to each interactive behavior in the conversion link, and the behavior prediction network corresponding to the interactive behavior being configured to predict the behavior occurrence possibility degree corresponding to the interactive behavior; and input the conversion prediction feature to the behavior prediction network corresponding to each interactive behavior to predictively obtain the behavior occurrence possibility degree corresponding to each interactive behavior.

For specific limitations on the object processing apparatus, refer to the above limitations on the object processing method, and elaborations are omitted herein. Each module in the object processing apparatus may be implemented entirely or partially through software, hardware, or a combination thereof. Each module may be embedded into or independent of a processor in the computer device in a hardware form, or may be stored in a software form in a memory in the computer device, for the processor to invoke to perform an operation corresponding to each module.

In some embodiments, a computer device is provided. The computer device may be a terminal. FIG. 9 is a diagram of an internal structure of the computer device. The computer device includes a processor (processing circuitry), a memory (a non-transitory computer-readable storage medium), a network interface, a display screen, and an input apparatus that are connected through a system bus. However, the term “processing circuitry” is meant to include one or more processors. Likewise, the term “non-transitory computer-readable storage medium” is meant to include one or more memories. The processor of the computer device is configured to provide calculation and control capabilities. The memory of the computer device includes a non-volatile storage medium and an internal memory. The non-volatile storage medium stores an operating system and computer-readable instructions. The internal memory provides a running environment for the operating system and the computer-readable instructions in the non-volatile storage medium. The communication interface of the computer device is configured for communication with an external terminal in a wired or wireless manner. The wireless manner may be implemented by using Wi-Fi, an operator network, near field communication (NFC), or another technology. The computer-readable instructions are executed by the processor to implement an object processing method. The display screen of the computer device may be a liquid crystal display screen or an e-ink display screen. The input apparatus of the computer device may be a touch layer covering the display screen, may be a button, a trackball, or a touchpad disposed on a housing of the computer device, or may be an external keyboard, touchpad, mouse, or the like.

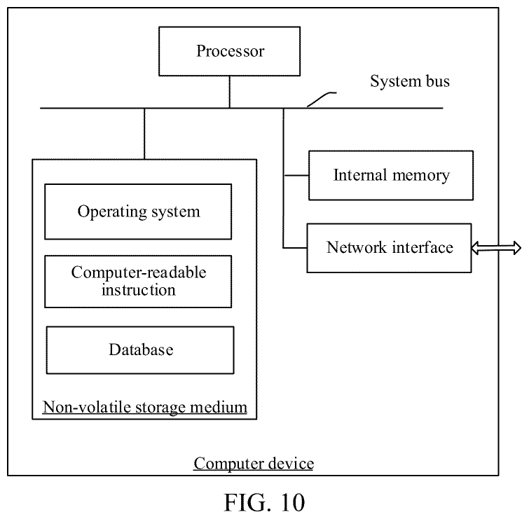

In some embodiments, a computer device is provided. The computer device may be a server. FIG. 10 is a diagram of an internal structure of the computer device. The computer device includes a processor, a memory, and a network interface that are connected through a system bus. The processor of the computer device is configured to provide calculation and control capabilities. The memory of the computer device includes a non-volatile storage medium and an internal memory. The non-volatile storage medium stores an operating system, computer-readable instructions, and a database. The internal memory provides a running environment for the operating system and the computer-readable instructions in the non-volatile storage medium. The database of the computer device is configured to store data involved in an object processing method. The network interface of the computer device is configured to be connected to an external terminal for communication through a network. The computer-readable instructions are executed by the processor to implement the object processing method.

It may be understood by a person skilled in the art that the structures shown in FIG. 9 and FIG. 10 are merely block diagrams of a partial structure related to the solutions of this disclosure and not intended to limit the computer device to which the solutions of this application are applied. The computer device may specifically include more or fewer components than those shown in the figures, or some components are combined, or different component arrangements are used.

In some embodiments, a computer device is also provided, which includes a memory and one or more processors. The memory stores computer-readable instructions. The computer-readable instructions, when executed by the processor, enable the one or more processors to perform the steps in each method embodiment.

In some embodiments, one or more non-volatile readable storage media are provided, which store computer-readable instructions. The computer-readable instructions, when executed by one or more processors, enable the one or more processors to perform the steps in each method embodiment.

A computer program product is provided, which includes computer-readable instructions. The computer-readable instructions are executed by a processor to implement the steps in the object processing method.

It may be understood by a person of ordinary skill in the art that all or some processes in the method of the foregoing embodiments may be completed by instructing related hardware by using computer-readable instructions. The computer-readable instructions may be stored in a non-volatile computer-readable storage medium. When the computer-readable instructions are executed, the processes in each of the foregoing method embodiments may be included. References to the memory, storage, the database, or another medium used in the embodiments provided in this disclosure may all include at least one of non-volatile and volatile memories. The non-volatile memory may include a read-only memory (ROM), a magnetic tape, a floppy disk, a flash memory, an optical memory, and the like. The volatile memory may include a random access memory (RAM) or an external cache. As a description instead of a restriction, the RAM may be in various forms, for example, a static RAM (SRAM) or a dynamic RAM (DRAM).

Technical features of the foregoing embodiments may be freely combined. For conciseness of description, not all possible combinations of the technical features in the foregoing embodiments are described. However, the combinations of these technical features shall be considered as falling within the scope recorded in this specification provided that no conflict exists.

The use of “at least one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof.

The foregoing disclosure includes some exemplary embodiments of this disclosure which are not intended to limit the scope of this disclosure. Other embodiments shall also fall within the scope of this disclosure.

What is claimed is:

1. An object processing method, comprising:
acquiring a historical interaction feature of a user with a historical resource object corresponding to a target resource object;
acquiring a historical status feature of the historical resource object, the historical status feature indicating a change of a resource attribute of the historical resource object;
determining a conversion prediction feature of the user for the target resource object at a current time based on the historical interaction feature and the historical status feature; and
predicting a conversion possibility degree of the user for the target resource object at the current time based on the conversion prediction feature, to determine whether to communicate with the user regarding the target resource object based on the conversion possibility degree.

2. The method according to claim 1, wherein
the historical status feature is associated with an influencing factor that comprises at least one of a value factor or a time factor, wherein the value factor dynamically changes over time; and
the acquiring the historical status feature comprises:
determining an interaction moment at which the historical interaction feature is generated, and determining time information at the interaction moment;
acquiring value information of the historical resource object at the interaction moment; and
determining the historical status feature based on at least one of the time information at the interaction moment or the value information of the historical resource object at the interaction moment.

3. The method according to claim 1, wherein the determining the conversion prediction feature comprises:
determining a following degree feature indicating a degree to which the user follows the target resource object at the current time based on the historical interaction feature and the historical status feature; and
determining the conversion prediction feature of the user for the target resource object at the current time based on the following degree feature.

4. The method according to claim 3, wherein the determining the following degree feature comprises:
for a respective interaction moment corresponding to each historical interaction with the historical resource object,
determining, a previous moment of the respective interaction moment;
acquiring a following status feature of the user at the previous moment to obtain a previous following status feature, the previous following status feature representing a degree to which the user follows the target resource object at the previous moment;
obtaining an incremental feature at the respective interaction moment based on the previous following status feature at the previous moment and the historical interaction at the respective interaction moment;
processing the incremental feature based on the historical interaction and a historical status feature at the respective interaction moment to obtain a following status feature at the respective interaction moment, the historical status feature at the respective interaction moment being at least one of a value factor of the historical resource object at the respective interaction moment or a time factor at the respective interaction moment; and
determining the following degree feature at the current time based on a following status feature at each interaction moment.

5. The method according to claim 4, wherein the processing the incremental feature comprises:
acquiring an aggregate feature of the user at the previous moment to obtain a previous aggregate feature, and determining an incremental weight corresponding to the incremental feature based on the historical interaction and the historical status feature;
determining an aggregate weight corresponding to the previous aggregate feature, and performing weighted calculation on the incremental feature and the previous aggregate feature based on the incremental weight and the aggregate weight to obtain an aggregate feature at the respective interaction moment; and
determining the following status feature at the respective interaction moment based on the aggregate feature at the respective interaction moment.

6. The method according to claim 5, wherein
the historical status feature comprises at least one of a time status feature at the respective interaction moment or a resource status feature at the respective interaction moment; and
the determining the incremental weight corresponding to the incremental feature comprises:
obtaining a first weight corresponding to the incremental feature based on the historical interaction at the respective interaction moment and the time status feature at the respective interaction moment;
obtaining a second weight corresponding to the incremental feature based on the historical interaction at the respective interaction moment and the resource status feature at the respective interaction moment; and
determining the incremental weight corresponding to the incremental feature based on at least one of the first weight or the second weight.

7. The method according to claim 5, wherein
the following status feature is generated by inputting the historical interaction and the historical status feature to a feature processing network corresponding to the respective interaction moment;
the feature processing network comprises an incremental weight prediction network; and
the determining the incremental weight corresponding to the incremental feature comprises:
inputting the historical interaction and the historical status feature to the incremental weight prediction network to predictively obtain the incremental weight corresponding to the incremental feature.

8. The method according to claim 7, wherein
the feature processing network further comprises an aggregate weight prediction network; and
the determining the aggregate weight corresponding to the previous aggregate feature comprises:
inputting the previous following status feature and the historical status feature at the respective interaction moment to the aggregate weight prediction network to predictively obtain the aggregate weight corresponding to the previous aggregate feature.

9. The method according to claim 4, wherein the determining the following degree feature comprises:
acquiring an object feature of the user and a current status feature of an influencing factor of the target resource object at the current time;
determining a weight corresponding to the following status feature at each interaction moment based on the object feature and the current status feature; and
performing weighted calculation on each following status feature by using the weight corresponding to each following status feature to determine the following degree feature at the current time.

10. The method according to claim 3, wherein the determining the conversion prediction feature comprises:
acquiring object information of the user;
encoding the object information to obtain an encoded object feature of the user; and
obtaining the conversion prediction feature of the user for the target resource object at the current time based on the encoded object feature of the user and the following degree feature.

11. The method according to claim 1, wherein the predicting the conversion possibility degree comprises:
acquiring a conversion link corresponding to the target resource object, the conversion link comprising an interactive behavior required to be performed by the user during conversion for the target resource object;
predicting, based on the conversion prediction feature for each interactive behavior in the conversion link, a possibility degree of occurrence of the interactive behavior of the user for the target resource object, to obtain a behavior occurrence possibility degree corresponding to the interactive behavior; and
obtaining the conversion possibility degree of the user for the target resource object at the current time based on each behavior occurrence possibility degree, the conversion possibility degree being in positive correlation with the behavior occurrence possibility degree.

12. The method according to claim 11, wherein the predicting, based on the conversion prediction feature, the possibility degree of occurrence of the interactive behavior comprises:
acquiring a previous behavior of the interactive behavior from the conversion link; and
predicting, based on the conversion prediction feature, the possibility degree of occurrence of the interactive behavior of the user for the target resource object when the previous behavior of the user has occurred, to obtain the behavior occurrence possibility degree corresponding to the interactive behavior.

13. The method according to claim 11, wherein the predicting, based on the conversion prediction feature, the possibility degree of occurrence of the interactive behavior comprises:
acquiring a trained object conversion prediction model, the object conversion prediction model comprising a behavior prediction network corresponding to each interactive behavior in the conversion link, and the behavior prediction network corresponding to the interactive behavior being configured to predict the behavior occurrence possibility degree corresponding to the interactive behavior; and
inputting the conversion prediction feature to the behavior prediction network corresponding to each interactive behavior to predictively obtain the behavior occurrence possibility degree corresponding to each interactive behavior.

14. An object processing apparatus, the apparatus comprising:
processing circuitry configured to
acquire a historical interaction feature of a user with a historical resource object corresponding to a target resource object;
acquire a historical status feature of the historical resource object, the historical status feature indicating a change of a resource attribute of the historical resource object;
determine a conversion prediction feature of the user for the target resource object at a current time based on the historical interaction feature and the historical status feature; and
predict a conversion possibility degree of the user for the target resource object at the current time based on the conversion prediction feature, to determine whether to communicate with the user regarding the target resource object based on the conversion possibility degree.

15. The apparatus according to claim 14, wherein
the historical status feature is associated with an influencing factor that comprises at least one of a value factor or a time factor, wherein the value factor dynamically changes over time; and
the processing circuitry is further configured to:
determine an interaction moment at which the historical interaction feature is generated, and determine time information at the interaction moment;
acquire value information of the historical resource object at the interaction moment; and
determine the historical status feature based on at least one of the time information at the interaction moment or the value information of the historical resource object at the interaction moment.

16. The apparatus according to claim 14, wherein the processing circuitry is further configured to:
determine a following degree feature indicating a degree to which the user follows the target resource object at the current time based on the historical interaction feature and the historical status feature; and
determine the conversion prediction feature of the user for the target resource object at the current time based on the following degree feature.

17. The apparatus according to claim 16, wherein the processing circuitry is further configured to:
for a respective interaction moment corresponding to each historical interaction with the historical resource object,
determine a previous moment of the respective interaction moment;
acquire a following status feature of the user at the previous moment to obtain a previous following status feature, the previous following status feature representing a degree to which the user follows the target resource object at the previous moment;
obtain an incremental feature at the respective interaction moment based on the previous following status feature at the previous moment and the historical interaction at the respective interaction moment;
process the incremental feature based on the historical interaction and a historical status feature at the respective interaction moment to obtain a following status feature at the respective interaction moment, the historical status feature at the respective interaction moment being at least one of a value factor of the historical resource object at the respective interaction moment or a time factor at the respective interaction moment; and
determine the following degree feature at the current time based on a following status feature at each interaction moment.

18. The apparatus according to claim 17, wherein the processing circuitry is further configured to:
acquire an aggregate feature of the user at the previous moment to obtain a previous aggregate feature, and determine an incremental weight corresponding to the incremental feature based on the historical interaction and the historical status feature;
determine an aggregate weight corresponding to the previous aggregate feature, and perform weighted calculation on the incremental feature and the previous aggregate feature based on the incremental weight and the aggregate weight to obtain an aggregate feature at the respective interaction moment; and
determine the following status feature at the respective interaction moment based on the aggregate feature at the respective interaction moment.

19. The apparatus according to claim 18, wherein
the historical status feature comprises at least one of a time status feature at the respective interaction moment or a resource status feature at the respective interaction moment; and
the processing circuitry is further configured to:
obtain a first weight corresponding to the incremental feature based on the historical interaction at the respective interaction moment and the time status feature at the respective interaction moment;
obtain a second weight corresponding to the incremental feature based on the historical interaction at the respective interaction moment and the resource status feature at the respective interaction moment; and
determine the incremental weight corresponding to the incremental feature based on at least one of the first weight or the second weight.

20. A non-transitory computer-readable storage medium storing computer-readable instructions thereon, which, when executed by processing circuitry, cause the processing circuitry to perform an object processing method comprising:
acquiring a historical interaction feature of a user with a historical resource object corresponding to a target resource object;
acquiring a historical status feature of the historical resource object, the historical status feature indicating a change of a resource attribute of the historical resource object;
determining a conversion prediction feature of the user for the target resource object at a current time based on the historical interaction feature and the historical status feature; and
predicting a conversion possibility degree of the user for the target resource object at the current time based on the conversion prediction feature, to determine whether to communicate with the user regarding the target resource object based on the conversion possibility degree.
